(19) United States
(12) Patent Application Publication
(10) Pub. No.: US 2026/0288732 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,025

(22) Filed: Mar. 14, 2026

(30) Foreign Application Priority Data
Mar. 19, 2025 (JP) 2025-045156

(51) Int. Cl. G06F 16/2457; G06F 16/21; G06F 16/25

(52) U.S. Cl. CPC G06F 16/24575; G06F 16/212; G06F 16/258

(57) ABSTRACT

A system includes a processor that is configured to provide an interface for receiving information from a user, analyze the received information by using a generative AI model, convert an analysis result into an appropriate format and write the analysis result into a database, and use a prompt that instructs the generative AI model to recognize an emotion of the user and to propose application content based on the emotion of the user.

### CROSS-REFERENCE TO RELATED APPLICATION

This application is based on and claims priority under 35 USC 119 from Japanese Patent Application No. 2025-045156 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional application support systems require a user to manually input structured data into predetermined fields and to understand internal database formats or service categories. As a result, when the user only has free-form natural language information, the user must translate such information into the specific items required by each service or database schema. This imposes a cognitive burden on the user, leads to input errors and omissions, and increases the time required to complete an application. In addition, conventional systems do not effectively utilize generative AI models to interpret user intent and emotion. Therefore, these systems have difficulty proposing suitable application content adapted to the user's emotional state, such as urgency, uncertainty, or dissatisfaction, and cannot automatically prioritize information or optimize the application content accordingly. Moreover, although natural language processing techniques exist, they are often not integrated in a unified manner to extract important keywords, automatically determine related services, and connect the extracted information to an internal database in an appropriate format. Thus, there is a need for a system that can receive natural language information from the user, analyze the information with a generative AI model and natural language processing techniques, recognize the user's emotion, automatically determine related services, and convert analysis results into an appropriate format for database registration while optimizing and prioritizing the application content.

### SUMMARY

In order to solve the above-described problems, a system comprising a processor is provided. The processor is configured to provide an interface for receiving information from a user, for example, a graphical user interface or an application programming interface that accepts free-form natural language text. The processor is further configured to analyze the information received from the user by using a generative AI model, convert an analysis result into an appropriate format corresponding to a database schema, and write the analysis result into the database. The processor is configured to use a prompt that instructs the generative AI model to recognize an emotion of the user and to propose application content based on the emotion of the user, so that the generative AI model can generate structured data and suggested content reflecting the emotional state, such as urgency or priority. The processor is also configured to analyze the information received from the user by using a natural language processing technique, extract important keywords from the information, and automatically determine a related service based on the extracted keywords, thereby enabling automatic selection of a target service or application type without requiring the user to understand internal classifications. Furthermore, the processor is configured to use a prompt that instructs the generative AI model to evaluate an emotional state of the user, set a priority of information based on an evaluation result of the emotional state, and optimize the application content based on the priority. By these means, the system allows natural language input from the user to be automatically analyzed, emotionally interpreted, mapped to related services, converted into a database-ready format, and optimized as application content with appropriate prioritization.
The term “system” refers to an information processing apparatus or a combination of hardware and software components that cooperatively execute the processing defined in the claims, including at least one processor and, optionally, memory, storage, network interfaces, and user interfaces.
The term “processor” refers to any hardware device or combination of devices that executes instructions, including but not limited to a central processing unit (CPU), a graphics processing unit (GPU), a microcontroller, a digital signal processor, or a programmable logic device, and may include a plurality of such devices operating together.
The term “interface” refers to a hardware and/or software mechanism by which the system receives information from a user or from another system, including, for example, a graphical user interface, a web interface, a command-line interface, an application programming interface (API), or a messaging interface.
The term “user” refers to a human operator or an entity acting on behalf of a human, who provides information or instructions to the system through the interface.
The term “information” refers to data, content, or instructions provided by the user in any form, including but not limited to natural language text, structured text, numerical values, selection inputs, or combinations thereof.
The term “generative AI model” refers to an artificial intelligence model that generates output data, such as text, structured data, or other content, in response to input data, including but not limited to large language models, transformer-based models, or other machine learning models capable of generative processing.
The term “prompt” refers to input data supplied to the generative AI model, including instructions, examples, or conditions, that guide the operation of the generative AI model and influence the content or format of its output.
The term “analyze” refers to processing input information in order to interpret, classify, extract, or transform the information, including identifying entities, relationships, intent, or emotions within the information.
The term “analysis result” refers to data obtained by analyzing the information provided by the user, including, for example, extracted fields, inferred attributes, classifications, recognized emotions, or proposed application content.
The term “appropriate format” refers to a data structure, schema, or representation that is suitable for storage in a database or for use by an application, including, for example, predefined column formats, JSON structures, or object models consistent with a database schema.
The term “database” refers to any structured data storage system, including relational databases, non-relational (NoSQL) databases, key-value stores, or other data repositories that store records corresponding to application content or analysis results.
The term “natural language processing technique” refers to any algorithmic or model-based method for processing human language, including tokenization, part-of-speech tagging, named entity recognition, sentiment analysis, topic classification, or other techniques used to interpret or transform natural language text.
The term “keyword” refers to a word, phrase, or token extracted from the information provided by the user that is determined to be important for identifying intent, related services, categories, or attributes of an application.
The term “related service” refers to a service, function, product, or application type that corresponds to or is appropriate for the information provided by the user, and that is automatically selected or suggested based on analysis of the user's information.
The term “emotion” refers to an affective state or attitude of the user, such as urgency, frustration, satisfaction, confusion, or other emotional conditions, as inferred from the user's information by the generative AI model or natural language processing techniques.
The term “emotional state” refers to a representation or evaluation of the user's emotion over at least a portion of the information provided by the user, including qualitative labels, scores, or categories that characterize the user's emotional condition.
The term “priority of information” refers to a relative importance or urgency assigned to pieces of information or application items based on the evaluation of the user's emotional state or other criteria, and used to determine processing order, emphasis, or resource allocation.
The term “application content” refers to structured or semi-structured data representing a request, application, or submission intended for a service, system, or process, including items such as requested actions, target systems, user attributes, reasons, and priorities.
The term “optimize the application content” refers to adjusting, reorganizing, supplementing, or refining the application content so that it better reflects the user's intent and emotional state, improves clarity and completeness, and is more suitable for processing by the target service or database.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

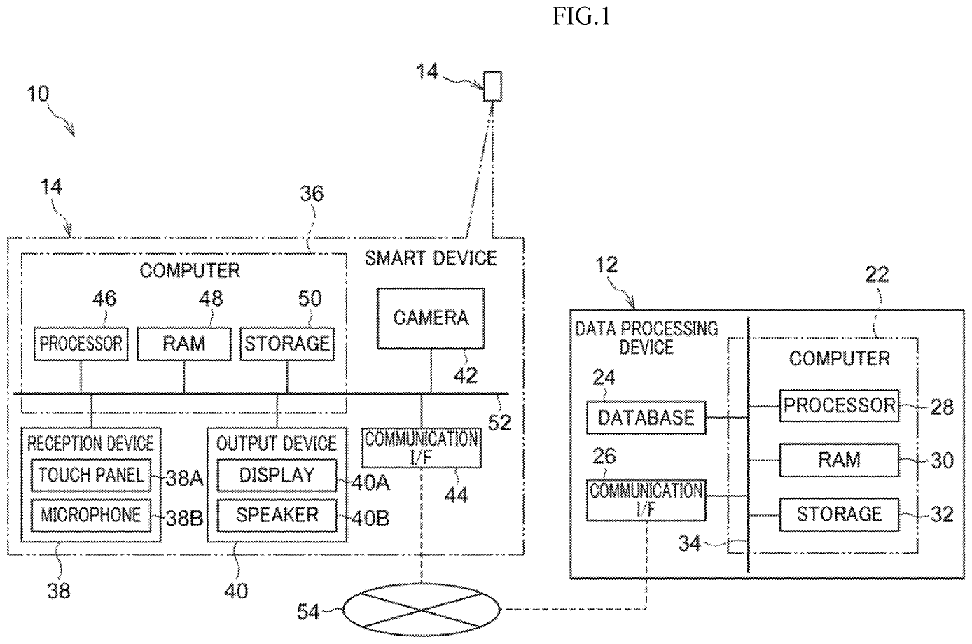

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

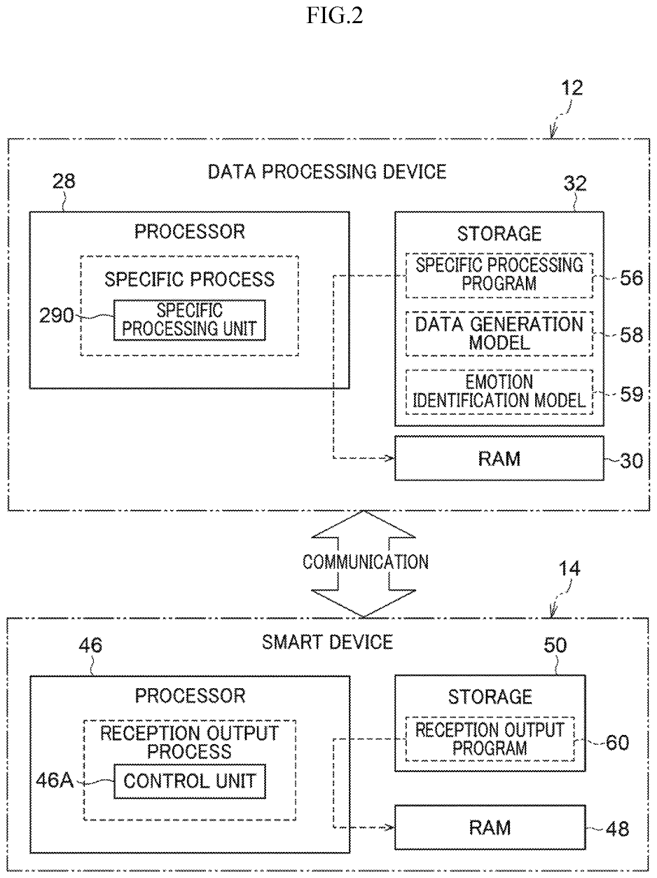

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented application processing systems require a user to manually understand complex form structures and to input structured data that conforms to rigid database schemas. In many cases, a user must translate their own natural language intent into specific fields such as project name, budget amount, applicant name, and service type, and must repeat this work whenever the form specification changes. This imposes a cognitive burden on the user, increases input errors, and results in incomplete or inconsistent records stored in backend databases.

From the perspective of computer technology, conventional systems also rely on static rule-based parsing or fixed templates to convert user input into database-ready records. Such systems are not robust to the variability of natural language expressions and cannot flexibly adapt to ambiguous, verbose, or emotionally colored input. As a result, the application logic must include complicated exception handling and validation routines, which increases processing complexity, degrades maintainability, and leads to inefficient utilization of computing resources in the server and the database management system.

Further, most existing systems treat user input as emotionally neutral and ignore the user's emotional state. This limitation prevents the system from dynamically adapting prompts, field priorities, and suggested application contents in a way that improves the efficiency and reliability of the overall data processing pipeline. In particular, when the user is confused, anxious, or uncertain, conventional interfaces cannot adjust the interaction strategy, which leads to repeated input attempts and increased server load due to unnecessary round trips and corrections.

Moreover, in many systems, the extraction of relevant service types or processing types from the user's free-form text is performed by separate classification modules that are not tightly integrated with the main parsing and data structuring process. This fragmented architecture introduces redundant parsing steps, duplicate data transformations, and additional latency, which negatively affects throughput and responsiveness in networked environments.

Therefore, there is a need for an improved computer-implemented system that (i) directly accepts natural language input from a user, (ii) uses a generative AI model to perform unified extraction, structuring, and emotional-state analysis, (iii) automatically converts the extracted information into a database-ready format, and (iv) dynamically controls prompt sentences and field prioritization based on the recognized emotional state. Such a system should reduce the cognitive burden on the user, simplify the server-side processing pipeline, and improve the efficiency, scalability, and robustness of data storage operations in the database management system.

The specific processing by the specific processing unit 290 of the data processing device 12 in Example 1 is realized by the following means.

The present invention provides a server comprising a processor configured to provide an input/output interface in an information processing apparatus for acquiring information expressed in natural language from a user, generate a prompt sentence for inputting the information expressed in natural language into a generative AI model and to control the prompt sentence so as to cause the generative AI model to extract items required for an application from the information expressed in natural language, analyze an extraction result output from the generative AI model, convert the extraction result into structured data including the items required for the application, perform format conversion of the structured data into a data format recordable in a data management system in a data storage device, write the format-converted structured data into a database via database management software and generate notification information for the user based on a write result, use a natural language processing technique included in the generative AI model to extract attribute information and important words related to the application from the information expressed in natural language and to automatically determine a processing type or a service type related to the application based on the attribute information and the important words, and cause the generative AI model to recognize an emotional state of the user from the information expressed in natural language, evaluate the emotional state, set a priority or a display order of the items required for the application based on an evaluation result, and dynamically change content or a presentation order of the prompt sentence according to the priority or the display order so as to optimize application contents. This enables the server to transform unstructured natural language input into consistent, database-ready structured records in a unified processing flow, while adaptively controlling interaction with the user based on the user's emotional state, thereby reducing user input burden, simplifying application logic, and improving the efficiency, robustness, and scalability of computer-based data processing and storage operations.
The term “system” refers to an arrangement of hardware and software components, including at least one processor, memory, and input/output interfaces, that cooperatively execute programmed instructions to perform application processing based on user input.
The term “processor” refers to a hardware computation unit, such as a central processing unit or a processing core, that executes machine-readable instructions to perform logical operations, data processing, and control of peripheral components.
The term “information processing apparatus” refers to an electronic device, such as a server device, client device, or terminal device, that includes at least a processor, a memory, and an input/output interface and is capable of executing application programs.
The term “input/output interface” refers to a hardware and/or software component for exchanging data between the system and an external entity, and includes, for example, a graphical user interface, a network interface, and an application programming interface.
The term “user” refers to a human operator who provides information to the system, receives information from the system, and initiates or interacts with application processing.
The term “information expressed in natural language” refers to content represented in a human language, such as sentences, phrases, or words, that is not constrained to a fixed structured format and is suitable for processing by natural language processing techniques.
The term “generative AI model” refers to a machine learning model that generates output data, such as structured representations, text, or other content, in response to input data, and that includes parameters trained using large-scale datasets to understand and produce natural language.
The term “prompt sentence” refers to a text string or sequence of instructions supplied to the generative AI model to specify a task, constrain output format, or guide interpretation of input information.
The term “extract” refers to the operation of identifying and obtaining specific items, attributes, or values from input information, such as application-related fields, using computational analysis.
The term “items required for an application” refers to data elements that are needed to construct an application record, such as a name of a subject, a numerical amount, an identifier of a requester, and other attributes defined by an application specification.
The term “extraction result” refers to data output by the generative AI model that describes one or more items identified from information expressed in natural language, including field names and corresponding values.
The term “structured data” refers to information organized according to a predefined schema or data model, such as key-value pairs, records, or objects, that can be stored and processed by database and data management software.
The term “data format” refers to a representation scheme for data, such as a binary format, textual format, or serialization format, which defines how information is encoded, stored, and transmitted.
The term “format conversion” refers to the operation of transforming data from a first representation, such as unstructured text or intermediate structured output, into a second representation, such as a database-ready record format.
The term “data management system” refers to software and associated control logic that manage the storage, retrieval, updating, and organization of data in one or more storage devices.
The term “data storage device” refers to physical storage hardware, such as a magnetic disk, a solid-state drive, or a non-volatile memory device, that retains digital data under control of the system.
The term “database” refers to an organized collection of structured data stored in a data storage device and managed by database management software according to a defined schema.
The term “database management software” refers to a software component that implements database management functionality, including data definition, data manipulation, query processing, transaction control, and access control.
The term “notification information” refers to data generated by the system for presentation to the user that indicates a result of processing, such as a success or failure of writing structured data into a database.
The term “natural language processing technique” refers to an algorithmic or model-based method that interprets, analyzes, or generates information expressed in natural language, including tokenization, parsing, classification, and semantic analysis.
The term “attribute information” refers to descriptive or categorical data associated with an application, such as types, categories, or properties that characterize the application.
The term “important words” refers to words or phrases in information expressed in natural language that have high relevance to determining application contents, categories, or processing types.
The term “processing type” refers to a classification of how the system should handle an application, such as a workflow type, operation category, or processing route determined based on extracted information.
The term “service type” refers to a category of service, function, or offering provided by an organization or system that is associated with an application, as determined based on extracted attribute information and important words.
The term “emotional state” refers to a condition of user sentiment, such as positive, negative, neutral, or a more detailed emotional category, inferred from information expressed in natural language by the generative AI model.
The term “evaluate” refers to the operation of quantitatively or qualitatively assessing a parameter, such as an emotional state, to produce a score, label, or classification used in subsequent processing.
The term “priority” refers to a relative importance level assigned to items required for an application, which influences processing order, display order, or emphasis within the system.
The term “display order” refers to a sequence in which items, prompts, or user interface elements are presented to the user on a display or other output device.
The term “content of the prompt sentence” refers to the specific wording, structure, and constraints included in a prompt sentence that is supplied to the generative AI model or presented to the user.
The term “presentation order of the prompt sentence” refers to the sequence and timing with which one or more prompt sentences are provided to the generative AI model or displayed to the user during interaction.
The term “optimize application contents” refers to improving the structure, completeness, clarity, or suitability of application data by adjusting prompts, priorities, and interaction patterns based on evaluated conditions, including the user's emotional state.

In one embodiment, a server cooperates with one or more terminals operated by users to implement the claimed system. The server includes at least one processor, a main memory, a non-volatile storage device, and a network interface. The terminal includes a processor, a memory, a display, an input device such as a keyboard or touch panel, and a network interface. The server and the terminal communicate over a network by using a communication protocol stack such as TCP/IP over Ethernet or a wireless communication standard.

The server executes an operating system, such as a general-purpose server operating system, and a server application program implemented, for example, by using a web framework and a database access library. The server application program includes a prompt control module, a generative AI interface module, a data transformation module, a database access module, and an emotional-state evaluation module. The server further cooperates with a database management system, such as a relational database management system, which runs on the same physical machine or on a separate machine and manages structured data stored in a persistent storage device.

The terminal executes a client application, such as a web browser or a native application, which presents a graphical user interface to the user. The terminal displays a prompt sentence to guide the user in entering information. For example, the terminal displays:
“Please enter the project name, budget amount, and applicant name.”

Alternatively, when the user starts a new application without knowing the detailed items, the terminal displays:
“To create a new budget application, please describe your project in one or more sentences. Include the project name, the approximate budget amount, and the applicant name.”

The user operates the terminal and inputs natural language text via the input device. The terminal captures the text as a character string and packages it into a structured message including metadata, such as a user identifier, a timestamp, and a language code. The terminal transmits this message to the server through the network interface using an encrypted communication channel.

The server receives the message and stores it temporarily in the main memory. The generative AI interface module of the server prepares an internal prompt sentence to be submitted to a generative AI model. The server generates, for example, the following prompt sentence as a system-level instruction to the model:
“You are a data extraction assistant. From the following user message, extract values for the fields: project_name, budget_amount, and applicant_name. Output only a structured representation with these fields.”

The server embeds the user's natural language text as the user message content and passes both the system-level prompt sentence and the user text to the generative AI model.

In one embodiment, the server uses a generative AI model implemented as a transformer-based neural network. The generative AI model includes an embedding layer that converts input tokens into dense vectors, a plurality of multi-head self-attention layers that process sequences of tokens, feed-forward layers that apply non-linear transformations, and an output layer that generates probability distributions over output tokens. The model has been pre-trained on large-scale corpora of natural language documents and further fine-tuned on domain-specific application texts and labeled field extraction data.

The server represents the input prompt sentence and user text as token sequences by applying a tokenizer. The generative AI model processes these token sequences and outputs a sequence of tokens that encodes the extracted fields in a structured format. Internally, the model computes attention weights between tokens based on learned weight matrices and applies non-linear activation functions to intermediate representations. The model adjusts its outputs based on the constraints expressed in the prompt sentence, such as requesting specific field names and a particular structure.

The server stores parameters of the generative AI model in the non-volatile storage device and loads them into the main memory at runtime. During training, the model has been trained by minimizing a loss function, such as a cross-entropy loss, between predicted token sequences and ground-truth sequences representing correct field extractions. A training process adjusts the model's weight parameters using an optimization algorithm, such as stochastic gradient descent or a variant thereof. Training uses mini-batches of input-output pairs and updates the weights by computing gradients of the loss function and modifying the weights to reduce the loss. Data augmentation techniques, such as paraphrasing of user messages and variation of field ordering, can be applied during training to improve robustness and coverage of the model.

The server uses the generative AI model not only to extract required items but also to recognize an emotional state of the user from natural language expressions. For this purpose, the server supplies an additional or alternative prompt sentence to the model, for example: “Determine the emotional state of the user from the following message. Classify the state as one of: positive, neutral, or negative, and provide a confidence score for each class.”

The generative AI model generates an output representing the emotional state of the user. In one embodiment, the model internally derives an emotional representation by mapping final-layer token embeddings to a smaller vector space and applying a softmax classifier trained to predict emotional categories. A training dataset used for this classifier includes example messages annotated with emotional labels and is used to update model parameters by minimizing a classification loss function. The server collects the predicted emotional category and associated confidence from the model output.

The server uses the emotional-state evaluation module to interpret the predicted emotional state and to derive a control signal for prompt adjustment. For example, when the user is classified as confused or uncertain, the server increases the level of guidance in subsequent prompt sentences and breaks down questions into smaller steps. Example adaptive prompt sentences generated by the server include:
“First, please enter only the project name.”
“Next, please enter the approximate budget amount.”

By contrast, when the user is recognized as confident or experienced, the server generates a more compact, single-step prompt sentence. This adaptive prompt mechanism reduces the number of round trips and clarification steps between the server and the terminal, thereby reducing communication load and processing overhead.

The server applies a deterministic algorithm in the prompt control module to compute which fields to ask for and in what order. The algorithm uses as inputs: a set of required items, a set of optional items, the predicted emotional state, and prior completion status of each item. The algorithm computes a priority score for each item by combining weights assigned to the item's importance and weights determined by the emotional state. The server then sorts items in descending order of priority and constructs prompt sentences accordingly. This rule-based prioritization is executed by the processor and is independent of human intervention, enabling consistent and reproducible adaptive interfaces.

The server also performs attribute extraction and processing-type or service-type determination. The generative AI interface module directs the generative AI model with a prompt sentence such as:
“From the following message, extract key attributes about the application, including category, urgency, and domain. Then determine an appropriate processing type and service type based on these attributes.”

The model outputs attribute information, such as keywords and categories, which the server converts into structured attributes. The server then applies a classification algorithm, such as a decision tree or a mapping table, that associates attribute combinations with specific processing types or service types. This deterministic classification, executed by the processor, replaces multiple manual routing rules and reduces complexity in downstream processing logic.

The data transformation module of the server converts the extraction result from the generative AI model into a structured data object conforming to a database schema. For example, the server maps “project_name,” “budget_amount,” and “applicant_name” into a record structure defined by the database management system. The server converts text representations of numbers into numeric types, normalizes date formats, and enforces data type constraints. The server also adds system-generated fields, such as an internal identifier, a creation timestamp, and a status indicator. The structured data object is then converted into a representation suitable for the database management system, such as a row in a relational table.

The database access module of the server transmits the structured data object to the database management system by invoking a database driver. The server constructs parameterized database commands to insert or update records, thereby reducing injection risks and improving performance through query plan reuse. The database management system records the data in the storage device and updates internal indexes to maintain efficient query performance. The server receives a result code and any generated identifiers from the database management system and generates notification information for the user, such as a message indicating successful registration and including the generated identifier.

The server returns the notification information to the terminal through the network. The terminal parses the notification information and displays a confirmation message to the user. An example confirmation message is:
“Your application has been successfully recorded. Project: AI Upgrade Plan, Budget: 200000, Applicant: Taro Suzuki.”

In another embodiment, the server executes the generative AI model locally by using a specialized computation unit, such as a graphics processing unit or a tensor processing unit. The server loads model parameters into high-bandwidth memory and uses optimized matrix multiplication algorithms to accelerate attention and feed-forward operations. By using such hardware acceleration, the server reduces processing latency for each request and increases throughput for many concurrent users. This improvement in computational efficiency translates into faster end-to-end response times from user input to database commit, which constitutes a technical improvement over non-accelerated implementations.

In yet another embodiment, the server integrates caching mechanisms at multiple levels. The server caches frequent prompt patterns and structural templates in the main memory, so that the server only needs to substitute user-specific content into existing templates rather than reconstructing prompts from scratch. The server also caches typical extraction results for recurrent expressions, such as common project phrases. The server uses hash-based lookup to determine whether an input text or its normalized variant has been processed before. When a cache hit occurs, the server bypasses the generative AI model for those parts and reuses previously generated structured data. This reduces the number of calls to the generative AI model and decreases computation load and network traffic to external AI services, thereby improving scalability and reducing communication overhead.

The server improves accuracy and robustness of extraction by combining the generative AI model's output with rule-based post-processing. For example, after receiving structured data produced by the generative AI model, the server applies regular-expression checks to numeric fields, normalization rules for currency values, and cross-field consistency checks. When the server detects inconsistencies, such as an impossible budget amount or mismatched name formats, the server invokes a secondary generative AI prompt that requests clarification on a specific field or reconstructs fields using stricter constraints. This two-stage processing pipeline results in lower error rates in stored data as compared with relying solely on a single-stage generative output or a purely rule-based parser.

The server thereby implements more than a simple automation of human tasks. The described configuration uses a specific combination of a transformer-based generative AI model, prompt control logic, emotional-state recognition, attribute extraction, rule-based prioritization, and database-aware data transformation to improve core aspects of computer operation. Processing speed is improved by hardware-accelerated model execution, caching, and reduced round-trip interactions. Accuracy of stored data is improved by structured extraction, emotional-state-aware prompting that reduces user mistakes, and post-processing validation. Data management is improved by generating normalized, schema-conforming records and consistent metadata, which lead to more efficient queries and lower storage redundancy. Communication load is reduced by adaptive prompts that minimize repeated corrections and unnecessary follow-up messages.

In addition, the server uses learning-based internal processing that is not limited to conventional human rules. The generative AI model captures complex context patterns and semantic relationships, enabling it to handle ambiguous, multi-sentence, and emotionally nuanced inputs that would be difficult to process through simple deterministic templates. At the same time, the server constrains and guides this learned behavior by explicitly designed prompt sentences and deterministic post-processing rules. This hybrid approach yields technical advantages in terms of stability, interpretability, and controllability of the system's behavior.

Alternative embodiments may differ in details of model architecture or training method while maintaining the same overall functional structure. For example, the generative AI model can be implemented as an encoder-decoder transformer, a decoder-only transformer, or another sequence modeling architecture. The model can be trained using supervised fine-tuning, reinforcement learning from human feedback, or a combination of both. Different loss functions, such as label-smoothed cross entropy or margin-based losses for emotional-state prediction, may be employed. The server can also incorporate additional features, such as attention to domain-specific terminology or subword segmentation optimized for a particular language.

The terminal implementation can vary as well. In one variant, the terminal runs a native application that performs local pre-processing, such as language detection, text normalization, and minimal keyword extraction, before sending the text to the server. In another variant, the terminal is a thin client that performs only display and input capture, with all natural language processing performed by the server. In either case, the server maintains ultimate control over prompt generation, generative AI invocation, and database interaction, ensuring that the technical improvements realized by the server-side architecture are preserved.

Through these embodiments and variations, the system provides a concrete implementation path for the claimed invention. The server, the terminal, and the database management system cooperate to form an integrated technical solution that transforms unstructured natural language input into reliable, efficiently stored structured data, guided by adaptive prompt sentences and controlled by learned and deterministic components working together inside the computer system.

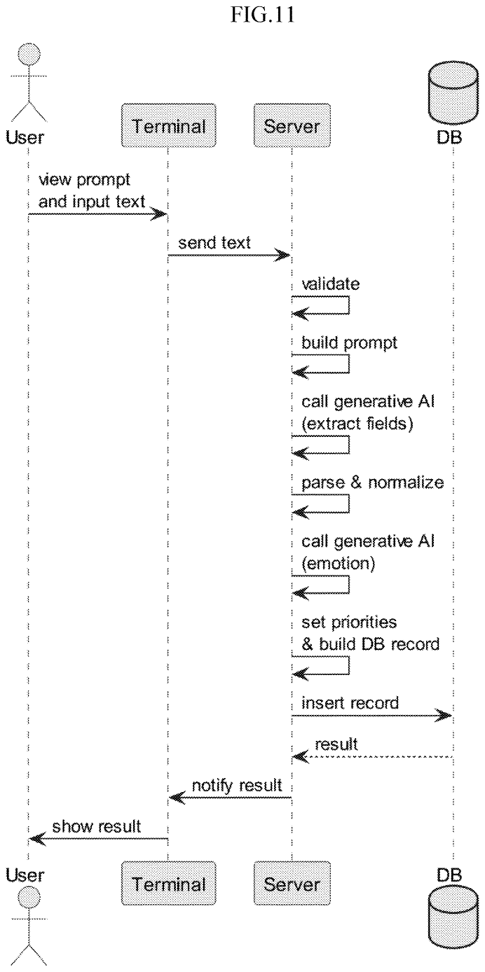

The following describes the processing flow using FIG. 11.

### Step 1:

The terminal displays a prompt sentence and acquires user input.

The terminal outputs, to a display device, a prompt sentence such as “Please enter the project name, budget amount, and applicant name.” or “To create a new budget application, please describe your project in one or more sentences. Include the project name, the approximate budget amount, and the applicant name.”

The user reads the prompt sentence and inputs natural language text through an input device, such as a keyboard or a touch panel.

The terminal receives the keystrokes or touch events as low-level input signals, converts them into character codes, and assembles them into a text string.

The terminal sets this text string, together with a user identifier and a timestamp, as the output of Step 1.

### Step 2:

The terminal packages the input and transmits it to the server.

The terminal takes, as input, the text string, user identifier, and timestamp generated in Step 1.

The terminal constructs a structured message object, for example an internal key-value structure, that contains fields such as “user_id,” “input_text,” “submitted_at,” and “language_code.”

The terminal serializes this structure into a transmission format, such as a text-based structured format, and sends it to the server via a network interface using an HTTP request over a secure channel.

The terminal outputs the serialized request as network packets directed to the server's network address.

### Step 3:

The server receives the request and performs initial validation.

The server takes, as input, the network packets containing the request from the terminal.

The server's network interface assembles the packets into an HTTP request, and the server parses the request body to reconstruct the structured message object.

The server checks that mandatory fields, including “input_text” and “user_id,” are present and non-empty, verifies that the message conforms to an expected schema, and confirms that the user is authenticated based on session or token information in the request headers.

The server outputs a validated input record that includes the user identifier, the natural language text, and associated metadata, or generates an error response if validation fails.

### Step 4:

The server generates a prompt sentence for the generative AI model.

The server takes, as input, the validated input record produced in Step 3.

The server constructs a model instruction that specifies extraction of required items. For example, the server generates the prompt sentence: “You are a data extraction assistant. From the following user message, extract values for the fields: project_name, budget_amount, and applicant_name. Output only a structured representation with these fields.”

The server embeds the user's natural language text as a separate segment following the instruction.

The server combines the instruction prompt sentence and the user text into an internal data structure representing an input sequence for the generative AI model, including token type markers separating instruction and user content.

The server outputs a fully formed model input sequence ready for tokenization.

### Step 5:

The server tokenizes the prompt and user text and feeds them to the generative AI model.

The server takes, as input, the model input sequence constructed in Step 4.

The server applies a tokenizer to convert the characters and words into a sequence of discrete tokens, each mapped to a numerical token identifier.

The server normalizes the text by applying lowercasing or subword segmentation, and then creates a token ID array and positional index array.

The server passes these arrays into the generative AI model's embedding layer stored in main memory. The embedding layer converts each token ID into a dense numerical vector and adds positional information.

The server outputs an embedded sequence representation as the input to the transformer layers of the generative AI model.

### Step 6:

The server causes the generative AI model to perform extraction of application items.

The server takes, as input, the embedded sequence representation generated in Step 5.

The server executes the transformer layers on the processor or an attached accelerator, performing multi-head self-attention and feed-forward computations on the embedded sequence. Each attention head computes weighted sums of token vectors based on learned weight matrices, and the model propagates these representations through multiple layers.

The server uses the model's output layer to compute probability distributions over possible output tokens at each position, constrained by the prompt sentence that specified the desired output structure.

The server decodes the most probable token sequence representing the structured extraction result, such as tokens forming “project_name: AI Upgrade Plan; budget_amount: 200000; applicant_name: Taro Suzuki”.

The server outputs this structured extraction string as the raw model result.

### Step 7:

The server parses and validates the extraction result from the generative AI model.

The server takes, as input, the raw structured extraction string produced in Step 6.

The server parses the string according to expected field labels and separators, constructing an internal key-value map for fields such as “project_name,” “budget_amount,” and “applicant_name.”

The server validates each field: it checks that the project name and applicant name are non-empty strings, and attempts to parse the budget amount as a numeric value.

The server applies normalization rules, such as removing extra whitespace, converting textual numbers into digits, and ensuring that the budget amount is non-negative.

The server outputs a validated and normalized field map that conforms to an internal application schema, or, if parsing fails, an error indicator used for re-prompting or error handling.

### Step 8:

The server obtains an emotional-state assessment from the generative AI model.

The server takes, as input, the original natural language text from Step 3 and may also use the validated field map from Step 7.

The server constructs another prompt sentence, for example: “Determine the emotional state of the user from the following message. Classify the state as one of: positive, neutral, or negative, and provide a confidence score for each class.”

The server re-tokenizes the combined classification instruction and user text and feeds them into the generative AI model's emotional classification head, which maps final-layer representations to an emotional label space.

The server obtains, as output, an emotional label (for example, “neutral”) and associated confidence scores, and represents this as an emotional-state record.

The server outputs the emotional-state record for use in prompt adaptation and prioritization.

### Step 9:

The server computes priorities for application items and constructs adaptive prompt sentences.

The server takes, as input, the validated field map from Step 7 and the emotional-state record from Step 8.

The server executes a priority computation algorithm that assigns a numerical score to each required item based on its importance and the user's emotional state. For instance, the server may assign higher priority to items that are missing or incomplete and increase guidance level when the emotional state indicates confusion.

The server sorts the items according to their priority scores and generates future prompt sentences that ask for missing or unclear items in the computed order. Example adaptive prompts include: “First, please enter only the project name.” and “Next, please enter the approximate budget amount.”

The server outputs an updated prompt specification and, if needed, a new prompt sentence to be sent back to the terminal.

### Step 10:

The server transforms the validated fields into database-ready structured data.

The server takes, as input, the validated field map produced in Step 7 and any additional attributes, such as processing type or service type, computed using extracted attributes.

The server maps each field to a column in a database schema and constructs a record object containing column names and corresponding values.

The server converts data types (for example, converting the budget amount into a numeric type with fixed precision) and adds system-generated fields such as a record identifier placeholder, a creation timestamp, and a status field.

The server outputs a complete database record structure that matches the schema managed by the database management system.

### Step 11:

The server writes the structured data to the database and creates a notification message.

The server takes, as input, the database record structure produced in Step 10.

The server generates a parameterized insert command and passes it, via a database driver, to the database management system. The database management system writes the record into persistent storage and returns a status code and, if applicable, a generated record identifier.

The server interprets the status code to confirm success or detect failure and constructs a notification message for the user. An example notification message is: “Your application has been successfully recorded. Project: AI Upgrade Plan, Budget: 200000, Applicant: Taro Suzuki.”

The server outputs both the database write result and the user-facing notification text.

### Step 12:

The terminal receives the notification and presents the result to the user.

The terminal takes, as input, the notification message sent by the server in Step 11.

The terminal parses the response, extracts the notification text, and renders it on the display using its graphical user interface framework.

The terminal may also update local state, for example by recording that the current application has been completed and resetting input fields for a potential new application.

The terminal outputs the visual representation of the confirmation or error message to the user, thereby completing one full processing cycle from natural language input through storage of structured data.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic transaction systems typically rely on rigid, form-based user interfaces and rule-based validation logic executed by a processor. Such systems require users to enter transaction information, including payment details and address information, in precisely predefined formats. When users instead provide information in natural language, in partially missing format, or with inconsistent structure, conventional systems either reject the input or require multiple correction cycles. As a result, the processor must perform repeated error handling and user interaction, which increases processing latency, server load, and network traffic, thereby degrading overall throughput of the information processing apparatus.

Furthermore, conventional systems treat user input as syntactic data only and do not exploit semantic analysis of user intent or emotional state. The processor therefore cannot dynamically adapt the transaction flow or proposed application content to the user's current condition. This limitation often causes inefficient interaction patterns, such as unnecessary confirmation steps or inappropriate prioritization of information, which in turn underutilize available computational resources and lead to suboptimal allocation of database operations and network responses.

Still further, in conventional architectures, the mapping from unstructured or semi-structured text input to database-ready structured records is implemented by manually coded transformation rules. As transaction services diversify, these rules become increasingly complex, difficult to maintain, and computationally expensive to evaluate. The processor must execute large numbers of conditional branches and string processing operations for every transaction, which increases CPU cycles per transaction and makes the system less scalable. Moreover, many existing systems perform data normalization and database insertion as separate, loosely coupled steps, leading to redundant intermediate representations in memory and on storage, and causing additional overhead in data consistency checks.

Additionally, typical systems either store sensitive information in a monolithic manner or apply static encryption policies independent of the semantic structure of the data. The processor cannot flexibly determine which elements of the transaction data should be encoded, partially retained, or masked based on generated structure and context. This rigid handling of sensitive information results in either excessive exposure risk or unnecessary computational overhead for encrypting and decrypting data that does not require full protection.

Accordingly, there is a need for an improved computer-implemented electronic transaction system in which a processor can: (i) accept natural language transaction input from a user, (ii) construct and supply prompt sentences to a generative AI model to perform semantic analysis including emotional-state recognition and transaction-content generation, (iii) convert the output of the generative AI model directly into structured data conforming to a database schema, and (iv) perform, in a tightly integrated flow, optimized mapping, normalization, and secure recording of the structured data in an information recording medium. Such a system should reduce the number of rule-based transformations, decrease per-transaction processing cost, and enhance the efficiency, scalability, and security of the underlying computer technology.

The specific processing by the specific processing unit 290 of the data processing device 12 in Application Example 1 is realized by the following means.

The present invention provides a server comprising a processor configured to receive, via an information input-output device, information including natural language transaction information from a user; construct a prompt sentence for inputting the received information to a generative AI model, the prompt sentence instructing the generative AI model to recognize an emotional state of the user, to propose application content related to an electronic transaction, and to convert the application content into a format for recording in a database; execute the generative AI model based on the prompt sentence and the received information so as to analyze the emotional state of the user, to generate the application content related to the electronic transaction, and to convert the application content and the transaction information into structured data that conforms to a schema of the database; perform a recording process using the structured data, the recording process including at least one insertion process to a relational information recording medium to safely record information related to the electronic transaction, and to notify the user of completion information based on a result of the recording process; and apply, to sensitive information included in the structured data, at least one of an encoding process and a partial-retention process so as to maintain integrity and confidentiality of information in the database. This enables the server to offload complex syntactic and semantic parsing from rule-based program code to the generative AI model, to directly obtain database-ready structured data from unstructured natural language input, to reduce the number of transformation stages and conditional branches executed by the processor, to streamline memory and storage access patterns during transaction processing, and to improve overall computational efficiency, scalability, and security of electronic transaction handling in the underlying computer system.
The term “processor” refers to a hardware or virtual computation unit, such as a central processing unit or a processing core, configured to execute program instructions to perform information processing operations.
The term “information input-output device” refers to a hardware or software interface component, such as a terminal device, user interface, or communication interface, configured to receive information from a user and to provide information to the user.
The term “natural language transaction information” refers to transaction-related content expressed in a human language, including but not limited to payment details, address information, identifiers, and instructions, that is not constrained to a predefined structured format.
The term “generative AI model” refers to a machine-learning model, such as a neural network-based language model, configured to generate or transform data, including natural language text and structured data, in response to input data and prompt sentences.
The term “prompt sentence” refers to a text sequence or instruction string supplied to the generative AI model and configured to specify a processing task, a desired output structure, or a processing constraint for the generative AI model.
The term “emotional state of the user” refers to a condition or attitude of the user, such as satisfaction, dissatisfaction, hesitation, or urgency, inferred from the user's input or interaction pattern.
The term “application content” refers to information representing a request, submission, or transaction specification in an electronic process, including fields necessary for executing an electronic transaction.
The term “electronic transaction” refers to a computational operation related to a commercial or administrative activity, including purchase, payment, registration, or application, performed through an information communication network.
The term “database” refers to a logical storage structure implemented on an information recording medium and configured to store, manage, and retrieve structured data according to a defined schema.
The term “schema of the database” refers to a logical definition of data organization, including table structures, field names, data types, and relationships among data elements in the database.
The term “structured data” refers to data that is organized according to predetermined item names, data types, and relationships so as to be directly storable in the database in conformity with the database schema.
The term “relational information recording medium” refers to a storage medium and associated control mechanism configured to store data in a relational structure, such as tables with records and fields, accessible through relational operations.
The term “recording process” refers to a sequence of operations executed by the processor to write, update, or maintain data in an information recording medium.

The term “insertion process” refers to a database operation that creates and stores a new record in a storage structure, such as a table in a relational database.

The term “completion information” refers to response data generated by the processor to indicate that a recording process or an electronic transaction has been successfully completed or has reached a predetermined state.
The term “sensitive information” refers to data elements that require protection against unauthorized access or disclosure, including but not limited to financial identifiers, personal identifiers, and authentication-related information.
The term “encoding process” refers to a conversion operation that transforms information into a different representation, such as encryption or encoding, for the purpose of protection or controlled accessibility.
The term “partial-retention process” refers to an operation that stores only a subset or masked portion of a data element, such as a truncated identifier, while discarding or obfuscating the remaining portion.
The term “integrity of information” refers to a property that stored data accurately represents the intended content and is protected against unauthorized or unintended modification.
The term “confidentiality of information” refers to a property that stored data is protected against unauthorized access or disclosure to entities that do not have permission to view the data.
The term “identifier” refers to data that uniquely or distinctively indicates a user, transaction, or object, such as an identification code, token, or label.
The term “time information” refers to data representing a temporal aspect, such as a date, time of day, timestamp, or time interval, associated with a transaction or event.
The term “transaction type information” refers to data indicating a category or kind of transaction, such as purchase, cancellation, subscription, or renewal.
The term “text sequence” refers to an ordered series of characters or tokens that together form a textual representation, such as a sentence, paragraph, or combined description.
The term “payment method” refers to a mode of settlement used in a transaction, such as a credit-based method, debit-based method, or digital wallet-based method.
The term “deadline information” refers to data representing a due date, expiration date, or other temporal limit associated with a transaction or obligation.
The term “location information” refers to data representing a geographic or physical place, such as a mailing address, region, or facility designation.
The term “identification information” refers to data that serves to identify a subject, such as a user, payer, or recipient, including names, codes, or account references.
The term “information recording medium” refers to a physical or virtual storage resource, such as a magnetic disk, solid-state memory, or cloud storage resource, configured to store digital data.
The term “mapping process” refers to a transformation operation that associates elements of structured data with corresponding item names and data types defined in a schema of an information recording medium.
The term “conversion process” refers to a transformation operation that changes a representation of data, such as converting date information into a standard format.
The term “standard format” refers to a predefined representation of data that complies with a consistent rule set, such as a particular date or address notation, used for uniform processing and storage.
The term “division process” refers to an operation that separates a composite data element, such as a full address string, into multiple constituent items, such as region, locality, and detailed address.
The term “distribution process” refers to an operation that allocates parts of structured data to multiple storage structures, such as different tables in a relational database.
The term “table structure” refers to a logical arrangement of data in rows and columns as defined in a relational schema.
The term “update process” refers to a database operation that modifies existing records in an information recording medium based on new or corrected data.

The server, the terminal, and the user cooperate to implement the embodiments of the invention as described below. Each embodiment supports the scope of the claims and can be realized using general-purpose computing hardware and software components.

The server comprises at least one processor, a main memory, a non-volatile storage device, and a network interface. The server executes an operating system, such as a general-purpose server operating system, and an application platform, such as a scripting runtime environment. The server further executes a web application framework, a database engine, and a machine learning runtime such as a numerical computation library with support for neural networks. The server stores, in the non-volatile storage device, a trained generative AI model implemented as a neural network, a tokenizer configuration, a database schema definition, and executable server application logic.

The terminal comprises at least one processor, a display device, an input device such as a keyboard or touch panel, a memory, and a communication interface. The terminal executes a client operating system and a browser program or a native client program. The terminal displays a user interface for electronic transactions, acquires natural language input from the user, and transmits the input to the server via a communication network using a secure transport protocol.

The user operates the terminal to access a network address of the server and to initiate an electronic transaction. The user enters transaction-related information in natural language, such as payment details and address information, without being constrained to a fixed input format. The user may also enter subjective expressions indicating emotional state, such as urgency or hesitation, which the server later uses as part of the analysis.

The server uses the web application framework to receive the data transmitted from the terminal as structured request objects. The server stores the received data temporarily in memory in the form of key-value structures. The server then generates one or more prompt sentences as text strings based on the received natural language transaction information, associated identifiers, time information, and transaction type information. The prompt sentences describe explicit instructions to the generative AI model and define the required output structure.

The server constructs the prompt sentences in a deterministic manner using program logic executed on the processor. The server concatenates predefined instruction segments and dynamic content segments into a single text sequence. In one embodiment, the server constructs a prompt sentence in the following form:
“Analyze the following online transaction input. Recognize the user's emotional state. Propose an application content for the transaction. Convert the information into a database-ready structured format with fields: card_number, expiry_month, expiry_year, cardholder_name, billing_address, shipping_address. Output only one JSON-like structure and do not include explanations. User input: [USER_TEXT].”

In another embodiment, the server constructs a normalization-oriented prompt sentence in the following form:
“Normalize the payment and address information contained in the following text. Extract and format the data into fields: card_number, expiry_month, expiry_year, cardholder_name, address_line1, city, region, postal_code. Use numeric month and four-digit year. Correct minor user formatting errors. Input: [USER_TEXT].”

In another embodiment, the server constructs a language-agnostic prompt sentence in the following form:
“Regardless of the natural language of the user input, detect payment details and shipping address. Output a single structured record with fields: payment_method, card_number, expiry_month, expiry_year, cardholder_name, billing_address, shipping_address. Do not output any commentary. User input: [USER_TEXT].”

The server replaces the placeholder [USER_TEXT] with the actual natural language content received from the terminal. The server thereby defines, by programmatic construction of the prompt sentence, a non-generic transformation task tailored to the database schema and to the electronic transaction context.

The server uses a tokenizer module to convert the prompt sentence into a sequence of tokens and then into a sequence of token identifiers. The tokenizer may be implemented as a subword segmentation model, such as a byte-pair encoding or a wordpiece method, pre-trained on a corpus that includes transaction-related text. The server loads, from the storage device into main memory, the neural network parameters of the generative AI model. The generative AI model can be implemented as a multi-layer Transformer architecture including an embedding layer, a plurality of self-attention layers, feedforward layers, and an output projection layer.

The server configures the generative AI model with hyperparameters such as the number of layers, attention heads, hidden dimensions, and activation functions. For example, the server may use a configuration with twelve encoder-decoder layers, each with eight attention heads and a hidden dimension of 768 units, and may use a rectified linear unit or similar non-linear function. The server supplies the token identifiers as input to the neural network and instructs the machine learning runtime to perform inference using matrix multiplication kernels that are optimized for the hardware, such as vector instructions of a central processing unit or parallel operations of a graphics processing unit.

The server processes the neural network output to obtain a generated text sequence. The generated text sequence is designed, under the prompt constraints, to represent a structured record describing card number, expiry month, expiry year, cardholder name, billing address, shipping address, and optionally other derived fields such as transaction type or inferred urgency. The server decodes the token identifiers output by the model back into characters using the tokenizer. The server then parses the generated text according to a pre-specified grammar. In one embodiment, the server enforces that the generated data conforms to a key-value structure with known keys.

The server performs additional deterministic validation and normalization on the structured data. For example, the server performs a numeric range check on expiry_month and expiry_year, performs a checksum verification on the card_number using a checksum algorithm, and normalizes address components by splitting a concatenated address string into multiple fields based on delimiter patterns or additional parsing rules. The server thereby combines learned generative behavior of the model with explicit algorithmic post-processing by the processor.

The server then maps the validated and normalized fields to a database schema stored in the storage device. The database schema defines table structures, such as a user table, a payment instrument table, and a transaction table. Each table has columns with defined types, such as integer, variable-length character sequence, or timestamp. The server constructs in-memory records mapped to these columns. For example, the server maps the card_number and its metadata to a payment instrument table, maps user name and contact information to a user table, and maps transaction amount and status to a transaction table.

The server applies security-related transformations to sensitive information before storage. The server selects sensitive fields, such as full card numbers, personal identifiers, and security codes, based on a configuration or rule set. The server then applies an encoding process, such as encryption, using a cryptographic library. The server may encode the full card number and store only the last several digits in plaintext. The server thereby performs a partial-retention process on the sensitive information. This combination of encoding and partial retention reduces the risk of unauthorized disclosure while keeping enough information to display non-sensitive identifiers to the user.

The server uses a relational database engine, such as a lightweight file-based relational database, to store the structured and transformed data. The server opens a database connection and executes parameterized insertion operations that insert rows into the relevant tables within a single transaction. The server also performs update operations when the user modifies existing information. The server thereby uses the structured data produced by the generative AI model and post-processed by deterministic program logic to populate multiple related tables while maintaining referential integrity and transactional consistency.

The server constructs a response message that includes at least a transaction identifier, information about the status of the recording process, and masked portions of sensitive data, such as the last digits of a card number. The server sends this response to the terminal. The terminal renders the response on the display device for the user, for example, by showing a message indicating that the transaction has been successfully completed and by showing a reference number. The user confirms the result by viewing the display.

The server thereby performs a combined sequence of operations that is not a mere automation of human mental steps. The server uses the generative AI model to transform unstructured natural language input into structured, database-ready data in a single inference stage, whereas a human operator would typically perform multi-step reading, interpretation, and manual entry. The server uses programmatic prompt sentence construction to control the generative AI model in a way that couples emotional-state recognition, application content generation, and schema-specific normalization within one computational pipeline.

The server achieves technical improvements in several respects. The server reduces the number of rule-based parsing routines that the processor must execute for each transaction. By transferring the burden of feature extraction and mapping from a large set of hand-coded rules to a single neural inference over compact representations, the server reduces branch mispredictions and string-processing overhead in the processor pipeline. The server thereby improves throughput when processing many concurrent transactions.

The server also improves accuracy and consistency in data normalization. The generative AI model, by having been trained on large amounts of historical transaction text and schema-aligned records, can recognize a wider variety of user expression patterns than a simple regular-expression-based parser. The server therefore reduces parsing errors and required user corrections, which in turn reduces network round-trips between the terminal and the server.

The server improves data management by ensuring that the same generative AI model simultaneously performs semantic interpretation and structural formatting. Instead of first generating free-form annotated text and later parsing it again, the server uses prompt sentences that cause the model to output data in a structure aligned with the database schema. This reduces intermediate representations in memory and reduces redundant parsing stages, thus improving memory efficiency and cache utilization within the processor.

The server further improves communication efficiency because the terminal can transmit relatively raw, unformatted natural language input instead of highly structured, multi-field form data. This reduces the need for multiple client-side validation cycles and back-and-forth error messages. The server centralizes complex interpretation at the back end, allowing terminals with limited computational capacity to participate in secure electronic transactions.

The server implements the generative AI model using a specific architecture and learning method. In one embodiment, the server trains the Transformer model using a corpus containing natural language transaction dialogues and corresponding structured records. The server uses supervised learning with a cross-entropy loss function defined over token sequences representing the structured output. The server performs gradient-based weight updates, such as stochastic gradient descent with momentum or an adaptive learning rate method. The server may augment the training data by synthetically generating variations of user input expressions, such as synonyms, reordered phrases, and misspellings, so that the model becomes robust to real-world input noise.

The server configures the model to use special tokens that delimit fields in the output, ensuring that the generated text is easily parsed into keys and values. The server includes, for example, a prefix token indicating the start of the record, field separator tokens, and a suffix token indicating the end of the record. This token design is tailored to the database schema used in the electronic transaction system and enables faster and more reliable parsing in the post-processing phase.

The server distinguishes itself from conventional rule-based systems and from naive uses of language models by combining prompt sentence construction, schema-aligned output formatting, and integrated database operations. The server does not merely call a generic language model to generate human-readable text. Instead, the server defines and enforces a closed set of allowed output patterns that closely match the database structure. This design enables the processor to avoid expensive generic text analysis of model outputs and to directly map the generated data into relational tables.

The server, in alternative embodiments, may use different types of generative AI models, such as sequence-to-sequence recurrent networks or convolutional architectures, provided that the models can generate structured data conditioned on prompt sentences. The server may also use different database technologies, such as a distributed relational database or an in-memory database, while maintaining the same concept of schema-conforming structured output.

The terminal, in alternative embodiments, may be implemented as a mobile device, a desktop computer, or a dedicated kiosk. The terminal may provide additional input channels, such as speech recognition, and may convert speech into text before sending it to the server. The same server-side processing flow then applies to the resulting natural language transaction information.

The user may employ the system not only for payment transactions but also for other electronic applications, such as subscription management, service requests, or registration procedures, as long as the server is configured with appropriate prompt sentences and database schemas. The server can adjust the structure of prompt sentences to instruct the generative AI model to output different kinds of structured records while leveraging the same core architecture.

The server thus provides a technical solution in which the processor, by construction and application of specialized prompt sentences to a generative AI model and by tight integration with relational data storage, achieves improved processing speed, improved normalization accuracy, reduced computational overhead, and enhanced security in handling transaction-related data, thereby improving the functioning of computer technology used in electronic transaction systems.

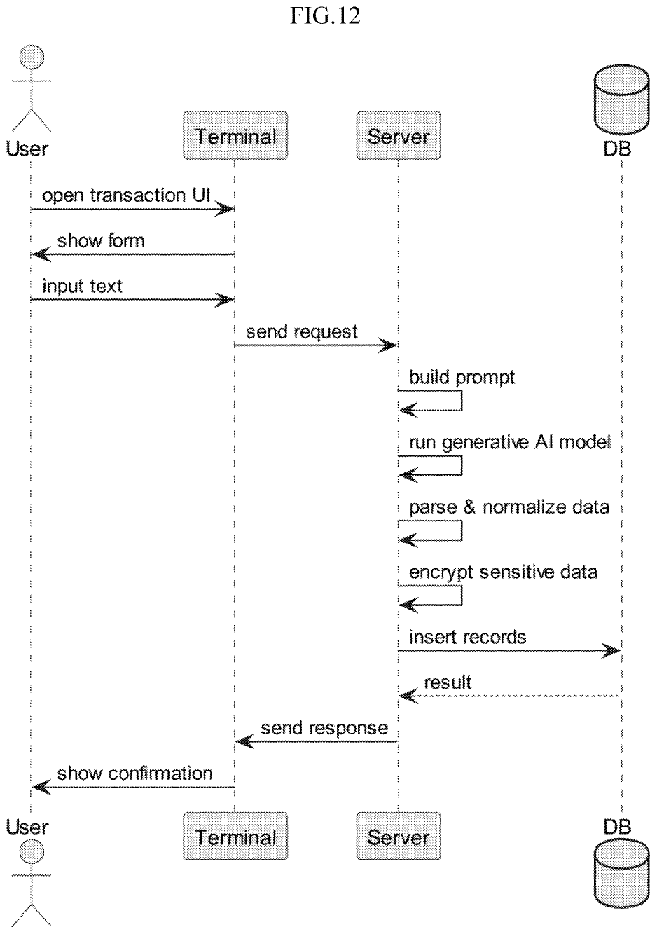

The following describes the processing flow using FIG. 12.

### Step 1:

The user operates the terminal to start an electronic transaction session by opening a client application or browser and accessing a network address of the server.

The terminal displays an input screen including at least one free-text field for natural language transaction information and optional structured fields such as transaction type or amount.
Input: The user's keystrokes or touch inputs representing natural language text (for example, payment details, address, and comments) and optional selection inputs (for example, transaction type).

The terminal converts the user's interactions into internal data structures, such as strings and key-value pairs, and renders them in the user interface so that the user can confirm the content visually.
Output: An in-memory representation of the user's natural language transaction information and metadata within the terminal.

### Step 2:

The terminal prepares a transmission payload containing the natural language transaction information, a user identifier, time information, and optional transaction type information.

The terminal encapsulates this payload in a network request, attaches security-related headers (for example, authentication tokens), and sends the request to the server via a secure communication protocol.
Input: The in-memory representation of user input and local metadata (for example, device identifier, timestamp).

The terminal serializes the data into a message format, performs necessary encoding (for example, character encoding), and transmits the serialized bytes over the network interface.
Output: A network message containing the user's transaction information delivered to the server.

### Step 3:

The server receives the network message through its network interface and passes it to a web application framework running on the processor.

The server decodes the message, validates the communication headers, and extracts the payload containing natural language transaction information and associated metadata.
Input: The serialized network message received over a transport connection.

The server deserializes the message into internal data structures (for example, dictionaries and strings), checks for required fields, and stores the parsed content temporarily in main memory for further processing.

Output: A validated and parsed request object containing user text, identifier, time information, and transaction type information.

### Step 4:

The server processes the parsed request object to construct a prompt sentence for the generative AI model.

The server concatenates fixed instruction templates with dynamic user-specific values, such as the natural language text and transaction context, into a single text sequence.
Input: The user text string, identifier, time information, transaction type information, and predefined prompt templates stored in memory.

The server performs string operations, including concatenation and placeholder replacement, to generate a structured instruction text, such as:
“Analyze the following online transaction input. Recognize the user's emotional state. Propose an application content for the transaction. Convert the information into a database-ready structured format with fields: card_number, expiry_month, expiry_year, cardholder_name, billing_address, shipping_address. Output only one structured record and do not include explanations. User input: [USER_TEXT].”
Output: A prompt sentence represented as a single text string ready to be provided to the generative AI model.

### Step 5:

The server uses a tokenizer module to convert the prompt sentence into model-compatible input.

The server splits the prompt sentence into tokens based on a predefined vocabulary, maps each token to a token identifier, and constructs input sequences with special tokens indicating sequence start and end.
Input: The prompt sentence text and a tokenizer configuration including a vocabulary and segmentation rules.

The server applies tokenization algorithms (for example, subword segmentation), encodes the tokens as integer arrays, and pads or truncates the sequences to match the expected input length of the generative AI model.
Output: A sequence of token identifiers and associated attention masks or positional indices for input to the generative AI model.

### Step 6:

The server loads the generative AI model into memory, if not already loaded, and configures the model for inference.

The server supplies the token identifier sequence to the generative AI model, which is implemented as a neural network architecture such as a multi-layer Transformer.
Input: The token identifier sequence, attention masks, and internal model parameters (weights and biases) stored in memory.

The server executes numerical operations including matrix multiplications, non-linear activations, and attention computations across multiple layers to generate output token probabilities step by step. The server may use specialized hardware instructions or accelerators to perform these operations efficiently.
Output: A sequence of output token identifiers or probability distributions representing the generated structured record in text form.

### Step 7:

The server decodes the output token identifiers back into a text representation of the structured record.

The server uses the same tokenizer in reverse to map each output token identifier to a text token and concatenates these tokens to form a text sequence describing structured data fields.
Input: The output token identifiers or probability distributions from the generative AI model.

The server applies a decoding algorithm (for example, greedy decoding) to choose the most probable token at each position, converts token identifiers to text, and stops decoding when an end-of-sequence token is detected.
Output: A generated text representing a structured record that includes fields such as card_number, expiry_month, expiry_year, cardholder_name, billing_address, and shipping_address.

### Step 8:

The server parses the generated structured text into a machine-readable structured data object.

The server expects a predefined pattern or delimiter structure and applies parsing rules to extract key-value pairs from the generated text.
Input: The generated structured text from the generative AI model.

The server scans the text for field names and delimiters, constructs a mapping from field names to values (for example, a dictionary), and validates that all required fields are present and non-empty.
Output: A structured data object containing extracted values for payment-related fields, address fields, and optional emotional-state or priority indicators.

### Step 9:

The server performs validation and normalization of the structured data object to ensure compatibility with the database schema.

The server checks numerical ranges (for example, month range and year), performs a checksum algorithm on card numbers, and normalizes date formats and address formats.
Input: The structured data object containing raw extracted values for each field.

The server executes deterministic algorithms such as range checks, checksum calculations, string normalization, and address splitting into multiple components (for example, address_line1, city, region, postal_code), thereby transforming loosely formatted values into standardized representations.
Output: A normalized and verified structured data object aligned with the database schema requirements.

### Step 10:

The server applies security transformations to sensitive data fields based on predefined security policies.

The server identifies fields such as full card numbers or personal identifiers and encodes them using a cryptographic or encoding function, while retaining only non-sensitive portions for display.
Input: The normalized structured data object and configuration data specifying which fields are sensitive and which encoding or masking methods to apply.

The server performs cryptographic operations or masking operations on the sensitive fields, generating encoded values and truncated or masked display values, and updates the structured data object to replace raw sensitive values with the encoded and masked forms.
Output: A security-enhanced structured data object with sensitive information encoded or partially retained according to policy.

### Step 11:

The server maps the security-enhanced structured data object to the relational database schema and prepares database records for insertion.

The server associates each field in the structured data object with the corresponding column in one or more tables, such as a user table, a payment instrument table, and a transaction table.
Input: The security-enhanced structured data object and the database schema definition including table names, column names, and data types.

The server constructs parameter arrays or tuples for each table, converts values to the appropriate data types, and groups related records so that referential constraints can be maintained during insertion.
Output: A set of prepared database insertion units specifying target tables, column lists, and parameter values.

### Step 12:

The server executes database operations to store the prepared records in the relational database.

The server opens a database connection, begins a transaction, and issues parameterized insertion statements to write records into the appropriate tables.
Input: The database insertion units and a handle or connection to the relational database engine.

The server transmits SQL commands with bound parameters to the database engine, which writes the data to persistent storage, and then commits the transaction if all operations succeed or rolls back in case of error, thereby maintaining data integrity.
Output: A database transaction result indicating success or failure and, in the case of success, assigned record identifiers such as primary keys.

### Step 13:

The server constructs a response message based on the database transaction result and the stored data.

The server includes in the response at least a transaction identifier, a status indicator, and non-sensitive summary information such as masked card digits and confirmation messages.
Input: The database transaction result, generated record identifiers, and masked or summarized portions of the transaction data.

The server formats this information into a response structure, serializes it into a protocol-compliant message, and sends the message to the terminal via the network interface.
Output: A response message containing transaction completion information delivered to the terminal.

### Step 14:

The terminal receives the response message from the server and processes it using the client application or browser.

The terminal decodes the message, extracts the transaction identifier, status, and displayable information, and updates the user interface accordingly.
Input: The serialized response message received over the network from the server.

The terminal deserializes the message, maps the contained fields to UI elements, and renders confirmation text such as “Payment completed successfully. Transaction ID: [ID]. Card ending in [digits].” on the display so that the user can confirm the result.

Output: A visual presentation of transaction completion on the terminal screen for the user.

### Step 15:

The user reviews the completion message displayed by the terminal and optionally stores or uses the transaction identifier for later reference.

The user may choose to initiate further actions, such as viewing transaction history or adjusting stored information, based on the confirmed result.
Input: The visual information presented on the terminal's display.

The user interprets the confirmation and, if desired, provides additional input to the terminal for subsequent interactions, thereby closing or extending the transaction process according to the user's needs.
Output: A user decision regarding completion or continuation of interaction with the electronic transaction system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented application management systems require a user to access multiple heterogeneous information processing systems individually and to manually adapt application content to different interfaces, data formats, and authorization schemes. Even when natural language interfaces are provided, the underlying systems typically rely on static rule-based parsing and manually configured mappings, which fail to robustly interpret diverse natural language inputs and cannot flexibly adapt to changes in target system specifications. As a result, the processor resources of server systems are inefficiently used for repetitive format conversion, error handling, and user interaction, leading to increased latency, higher error rates, and a heavy configuration burden for system operators.

Furthermore, in many existing systems, responses returned from multiple information processing apparatuses are delivered to the user in a raw or minimally processed form. The server often returns low-level status codes and technical messages, requiring the user or an operator to interpret heterogeneous results. This increases cognitive load, leads to misinterpretation of results, and causes unnecessary retries and support inquiries, thereby degrading overall system throughput and utilization efficiency of computing resources.

In addition, known techniques for using machine learning or conventional natural language processing in such systems are typically limited to keyword extraction or simple intent classification. These techniques do not leverage advanced generative models to produce structured application data, to dynamically normalize responses across multiple back-end systems, or to generate adaptive user guidance. As a consequence, the server is not able to centralize and automate the complete end-to-end flow from natural language input to multi-system application execution and explanation, and cannot substantially improve the internal operation of the computer system itself.

Moreover, existing systems rarely consider the user's emotional state as part of the control logic executed by the processor. Communication flows and prioritization of operations are usually fixed or based solely on static business rules. This can result in suboptimal presentation of results and guidance, such as presenting complex error information in a stressful situation without adaptation, which may cause repeated failed operations. From a computer technology perspective, this leads to unnecessary processing cycles, redundant communication with back-end systems, and inefficient utilization of storage and network resources.

Accordingly, there is a need for an improved computer-implemented system in which a processor cooperates with a generative AI model and structured configuration data to (i) interpret user-provided natural language prompt sentences into structured application information, (ii) automatically map such structured information to multiple heterogeneous information processing apparatuses and their interfaces, (iii) normalize and aggregate disparate response data into unified result information, and (iv) generate adaptive natural language explanations and guidance, optionally taking into account a user's emotional state. By tightly integrating these functions into the server-side processing sequence, the computer system can reduce manual intervention, lower protocol and format translation overhead, and improve robustness, latency, and overall efficiency of computational resources.

The specific processing by the specific processing unit 290 of the data processing device 12 in Example 2 is realized by the following means.

The present invention provides a server comprising a processor configured to receive, via an input/output device, a natural-language prompt sentence including application information from a user operating a terminal; to cause a generative AI model to analyze information including the prompt sentence and to obtain, from the generative AI model, structured information including at least an application target information processing apparatus, a requested authority type, and a user identifier based on control information that instructs the generative AI model to perform said analysis; to refer, on the basis of the structured information, to a storage device that stores setting information associated with a plurality of information processing apparatuses and to identify, for each application target, a corresponding information processing apparatus and a communication interface for transmitting and receiving data with the information processing apparatus; to convert the structured information into a request data format corresponding to each identified communication interface, to generate communication data including authentication information and authorization information, and to transmit the communication data to each corresponding information processing apparatus via the corresponding communication interface; to receive response data from each information processing apparatus in response to the communication data, to analyze the response data, and to generate normalized result information including at least an application result, identification information, and error information; to generate, on the basis of the normalized result information, a prompt sentence including control information that instructs the generative AI model to generate a summary of the result information and an explanation text for the user, to obtain the explanation text from the generative AI model, and to present the explanation text to the user via the input/output device; and to store the structured information and the normalized result information in a database as a data management apparatus. This enables the server to technically improve computer operation by centralizing, within a single processing pipeline, the interpretation of heterogeneous natural-language inputs, the automated selection and invocation of multiple heterogeneous back-end interfaces, and the normalization and adaptive explanation of results, thereby reducing manual configuration and error handling, lowering processing and communication overhead, and enhancing the efficiency, scalability, and robustness of the overall computer system.
The term “system” refers to an arrangement of one or more computing devices, storage devices, communication interfaces, and software components that cooperate to execute the functions described in the claims.
The term “processor” refers to a hardware processing unit, such as a central processing unit or a programmable processing circuit, executing computer-readable instructions to perform the operations described in the claims.
The term “input/output device” refers to a hardware and software interface, such as a display, a keyboard, a pointing device, a touch panel, a microphone, or a network interface, through which data is input to and output from the system.
The term “terminal” refers to a user-operated computing device, such as a personal computer, a mobile device, or a tablet device, that communicates with the system over a communication network.
The term “user” refers to an entity, such as a human operator or an automated client process, that interacts with the system by providing input and receiving output.
The term “prompt sentence” refers to a sequence of characters or tokens expressed in natural language, supplied by the user, and including at least an indication of application content or a request to perform one or more operations.
The term “application information” refers to data included in or derived from the prompt sentence, indicating at least a target resource, an operation to be performed, or a type of authority to be requested.
The term “generative AI model” refers to a machine learning model, such as a large language model, configured to generate or transform text or structured data in response to input prompts and control information.
The term “control information” refers to data, including instructions or parameters, used to specify an operation to be performed by the generative AI model, such as a requested output format or extraction target.
The term “structured information” refers to data organized in a predefined format, such as a key-value structure, a list, or a hierarchical record, that represents one or more attributes extracted from the prompt sentence.
The term “information processing apparatus” refers to a computing resource, such as an application server, a service platform, or a management system, that provides a specific function and processes requests received from the server.
The term “application target” refers to at least one information processing apparatus or resource to which an application or request indicated by the user is directed.
The term “requested authority type” refers to a classification of access or operation rights, such as a read-only right, a write right, or an administrative right, requested in relation to an application target.
The term “user identifier” refers to data, such as a user ID, an account name, or a numeric code, that uniquely or distinctively identifies the user within the system or within an external information processing apparatus.
The term “storage device” refers to a memory or data storage resource, such as a non-volatile memory device or a database storage medium, configured to store setting information, structured information, or result information.
The term “setting information” refers to configuration data that associates one or more application targets with corresponding information processing apparatuses, communication interfaces, authentication parameters, or request formats.
The term “communication interface” refers to a logical and physical interface, such as an application programming interface, a network endpoint, or a protocol stack, that enables data to be transmitted between the system and an information processing apparatus.
The term “request data format” refers to a predefined structure or encoding, such as a structured text format or a binary message format, used for transmitting requests to an information processing apparatus.
The term “communication data” refers to data, including request payloads, headers, and control fields, that is transmitted between the system and an information processing apparatus through a communication interface.
The term “authentication information” refers to data, such as credentials, tokens, or cryptographic signatures, used to verify the identity of the sender of a request.
The term “authorization information” refers to data, such as role identifiers, permission codes, or access scopes, used to indicate or grant permissible operations on a target resource.
The term “response data” refers to data returned from an information processing apparatus to the system in reply to communication data, including at least an indication of success, failure, or status.
The term “normalized result information” refers to data generated by transforming one or more units of response data from different information processing apparatuses into a unified representation comprising at least an application result, identification information, and error information.
The term “application result” refers to information indicating an outcome of an application, such as approval, rejection, or pending status, returned from an information processing apparatus.
The term “identification information” refers to data included in the normalized result information that enables identification of a particular application, transaction, or target system.
The term “error information” refers to data indicating a cause or type of error that occurred during processing of a request by an information processing apparatus or by the system.
The term “explanation text” refers to a natural-language output generated by the generative AI model, based on normalized result information, that explains application results or provides guidance for the user.
The term “database” refers to a data management apparatus, implemented by software and storage devices, configured to store, retrieve, and manage structured information and normalized result information.
The term “natural language processing” refers to a set of computational techniques for analyzing, interpreting, or transforming text or speech expressed in human language, including tokenization, parsing, classification, and information extraction.
The term “feature information” refers to extracted data elements, such as important terms, apparatus names, authority categories, or time-related information, used for determining related targets or processing types.
The term “attribute information” refers to data representing characteristics of the user, such as role, affiliation, past behavior, or profile data, that can be used to infer an emotional state or context.
The term “emotional state” refers to an estimated condition of the user, such as stress level, satisfaction, or urgency, determined from the prompt sentence and attribute information using the generative AI model.
The term “processing order” refers to a sequence or prioritization assigned to multiple application requests or notification operations based on one or more priority criteria.
The term “notification content” refers to information, including messages or alerts, that is generated and presented to the user to indicate processing status, results, or required actions.
The term “reapplication guidance content” refers to information presented to the user to instruct or suggest how to modify or resubmit an application after an error, rejection, or incomplete result.
The term “optimization of application content and explanation text” refers to adjusting one or more aspects of the structured information, the normalized result information, or the explanation text, including ordering, level of detail, or tone, according to priorities or user context in order to improve usability and processing efficiency.
The server implements an embodiment of the invention as a network-connected computer system including at least one processor, a memory device storing executable instructions, a non-volatile storage device storing configuration data and logs, and a network interface. The server executes operating system software such as a general-purpose server operating system and runs application server software such as a web framework environment. The server communicates with one or more terminals over a communication network using secure communication protocols.

The terminal operates as a user-facing computing device such as a personal computer, a tablet device, or a mobile device. The terminal includes a display device, an input device such as a keyboard, a pointing device, or a touch panel, a local processor, a memory device, and a communication interface. The terminal executes client software, such as a web browser or a dedicated application, that presents an input/output device interface to the user and communicates with the server using a network protocol. The terminal provides a text input region where the user can input a prompt sentence in natural language.

The user interacts with the system by operating the input device of the terminal. The user inputs, in a natural language, a prompt sentence that expresses an application to one or more information processing apparatuses. The user may input prompt sentences such as “I want to apply for read-only access to the customer data processing system for my account user_1234 starting from next Monday” or “Please submit applications so that I can access both the sales analysis system and the inventory management system with standard user privileges.” The terminal transmits the prompt sentence and associated metadata to the server through the network interface using an application protocol over a transport protocol.

The server stores, in the memory device, a program that, when executed by the processor, causes the server to implement a plurality of functional modules. In one embodiment, the server includes a communication module, a prompt analysis module, a configuration management module, a request generation module, a response normalization module, an explanation generation module, a data persistence module, and an emotional state evaluation module. The server implements these modules as software components executing on the processor and exchanging data via in-memory data structures.

The server, in the communication module, receives a prompt sentence from the terminal via the network interface. The server stores the received prompt sentence as character data in a buffer structure and converts the character sequence into a tokenized representation using a natural language pre-processing library. The server also associates the prompt sentence with a user identifier, a timestamp, and a session identifier and stores this association in a volatile data structure for subsequent processing.

The server uses the prompt analysis module to interact with a generative AI model. The server executes, on the processor, a client library that constructs an input data structure for the generative AI model. The server includes, in the input data structure, a system-side prompt specifying extraction tasks and output formats, and the user's prompt sentence as content to be analyzed. The server transmits this input data structure to a model execution environment. In one embodiment, the server hosts the generative AI model on a dedicated model server that implements a transformer-type neural network. The transformer network includes an embedding layer, multiple self-attention layers, feed-forward layers, and a final projection layer. Each self-attention layer implements scaled dot-product attention with multi-head attention units.

The server configures the generative AI model such that the model is trained on token sequences representing natural language prompts and structured output formats. During training, the model minimizes a loss function such as a cross-entropy loss between predicted token sequences and ground truth token sequences. The model updates internal weight parameters using an optimization algorithm such as stochastic gradient descent with a variant such as Adam. The server uses a training dataset that includes examples of input prompt sentences and corresponding structured representation of target system names, requested authority types, user identifiers, temporal constraints, and other relevant attributes. The server optionally augments the training data by paraphrasing prompt sentences and by injecting variations in entity naming and date expressions to increase robustness.

The server receives, from the generative AI model, an output sequence representing structured information. The server parses the output sequence according to a predetermined schema to obtain structured information including at least an application target information processing apparatus, a requested authority type, and a user identifier. The server stores the structured information in a structured in-memory object, for example a mapping from attribute names to attribute values.

The server uses the configuration management module to map the application target information processing apparatus to physical or logical endpoints. The server stores, in the storage device, configuration records that relate abstract target names to specific information processing apparatuses and their associated communication interfaces, such as base URLs, protocol types, authentication methods, and supported operations. The server performs a lookup operation in the configuration records using the target name present in the structured information. The server resolves ambiguities and synonyms by performing a similarity computation between the target name and candidate configuration entries, for example by computing vector embeddings of textual identifiers and selecting an entry that maximizes a similarity measure.

The server, in the request generation module, synthesizes request data structures for each identified information processing apparatus. The server maintains, for each apparatus, a request template that specifies required fields, data types, and format constraints. The server populates these templates with values derived from the structured information. For example, the server maps a requested authority type such as “read-only” to a permission code defined by the apparatus configuration, such as a code representing a reading role. The server converts date phrases such as “next Monday” into absolute date values by computing future dates using the system clock and a calendar calculation algorithm. The server serializes the populated templates into request payloads, such as structured text or binary structures, and attaches authentication information such as tokens, keys, or signed messages. The server generates authentication information by interacting with an authentication service, performing cryptographic operations including hashing and signing.

The server transmits the request payloads as communication data through the network interface to each information processing apparatus using the appropriate communication interface. The server manages network sessions, retries, and timeouts to ensure robust communication. The server schedules sending operations to control traffic and avoid overloading network resources, thereby reducing communication load compared with naive approaches that send separate and redundant requests.

The server receives response data from each information processing apparatus in the communication module. The server parses response payloads according to apparatus-specific response formats specified in configuration records. The server extracts status indicators, identifiers, and error codes from the response data. The server converts heterogeneous response formats into a normalized result information structure managed by the response normalization module. The normalized result structure includes, for each apparatus, an application result, an identification information field such as a request ID, and error information where applicable.

The server employs specific data structures for normalized results, such as indexed collections where each entry corresponds to a target apparatus and contains fields for status, message, codes, and timestamps. The server may perform additional computations such as aggregating statuses to determine an overall success rate or detecting partial failures. This normalization process reduces complexity for subsequent processing modules and allows efficient iteration and aggregation using indexed access, reducing processing time and memory overhead.

The server uses the explanation generation module to produce user-oriented explanation texts. The server constructs a second-level prompt sentence addressed to the generative AI model. This second-level prompt sentence includes control information specifying that the model should produce a concise summary of normalized results and optional detailed guidance for resolving errors. The server embeds the normalized result information into the control instructions as a structured description. The server transmits this combined input to the generative AI model, which generates an explanation text in natural language that rephrases and organizes technical data for human comprehension.

The server shapes the generative AI model behavior for explanation generation by using a specialized fine-tuning procedure. In one implementation, the server trains the model with pairs of normalized result data and target explanation texts under an instruction-following objective. The training process uses a sequence-to-sequence prediction objective with teacher forcing and a loss function such as cross-entropy across the output tokens. The server may fine-tune the model to adjust tone and detail level according to meta-parameters or user attributes. This model configuration yields explanation texts that preserve essential technical information while reducing cognitive load.

The server presents the explanation text to the user via the terminal. The server transmits the explanation text through the network interface to the terminal, and the terminal displays the text on the display device, optionally with emphasis or color coding for success and error messages. The user reads the explanation and, if necessary, inputs a modified prompt sentence to correct or refine the application content. By centralizing display logic in the terminal and explanation generation in the server, the system reduces the need for custom interface implementation per target apparatus.

The server implements an emotional state evaluation module to further improve the computer's behavior. The server configures the generative AI model or a separate classifier network to estimate an emotional state of the user, such as stress level or urgency, based on lexical features, punctuation usage, and historical interaction patterns present in the prompt sentence and stored attribute information. The server uses a feature extraction pipeline that computes numerical features such as sentence length, frequency of emphasis tokens, and the presence of urgency words. The server forwards these features, together with prompt tokens, to a neural network. The neural network outputs a vector representing probabilities of different emotional categories. The server assigns the category with highest probability as the estimated emotional state.

The server applies the emotional state information to adjust internal prioritization and presentation strategies. For example, the server may alter the ordering of items in normalized result information, cause critical errors to be highlighted when the user appears confused, or reduce detailed technical data when the user appears stressed. The server propagates these decisions into the explanation generation module via control information encoded into the second-level prompt sentence. This adaptation is not a mere automation of human judgment but a computation that optimizes data placement and representation in the computer system, thereby decreasing the number of repeated requests and reducing overall processor and network utilization.

The server improves computer technology in multiple aspects. First, by offloading semantic parsing and mapping of heterogeneous targets to a transformer-based generative AI model, the server reduces the complexity and quantity of static rules required in conventional systems. The server includes only high-level configuration records and uses learned attention patterns inside the model to relate tokens in the prompt sentence to target apparatus configurations. This replaces brittle rule-based parsers with a model that generalizes across variations, reducing parsing errors and the corresponding number of error-handling cycles.
Second, the server improves data management by converting natural language inputs into structured information with a stable schema. This structured information can be indexed, searched, and cached using database mechanisms. The server defines table structures for logging prompt sentences, structured information, normalized results, and model outputs. The server uses indexing strategies over fields such as user identifier, target apparatus, and timestamp to accelerate retrieval operations. This organization reduces database query complexity and improves throughput.
Third, the server reduces communication load by mapping a single prompt sentence that references multiple targets into an aggregated set of communication operations executed according to optimized ordering. The server can schedule communication based on apparatus latency profiles stored in configuration records. For example, the server may group requests to high-latency apparatuses early to hide latency behind processing of lower-latency apparatuses. This scheduling algorithm reduces global response time for the user and utilizes network bandwidth more efficiently.
Fourth, the server improves calculation efficiency by structuring data flow through explicit modules. Each module operates on specific data structures and passes outputs to the next module, avoiding redundant parsing and serialization. For example, the server maintains internal representations of structured information and normalized results so that explanation generation can operate directly on in-memory structures without re-reading data from external storage.
Fifth, the server leverages training-time optimization of the generative AI model to achieve higher accuracy in mapping prompt sentences to structured information. During training, the server uses a validation set to monitor error metrics and adjust hyperparameters such as learning rate, batch size, and sequence length. The server may perform model distillation to deploy a lighter-weight model with lower computational footprint on the server hardware, retaining most of the accuracy. This approach leads to faster inference at runtime, reduces processor load, and improves system responsiveness.

The terminal cooperates with the server to realize end-to-end functionality. The terminal performs local validation of user input format where appropriate, such as checking that the prompt sentence field is not empty. The terminal may optionally pre-process the prompt sentence, for example by normalizing whitespace or encoding characters in a consistent form. The terminal logs user actions such as submission times, which can be used by the server for rate limiting or anomaly detection. By relocating only minimal logic to the terminal and keeping the majority of complex operations server-side, the system simplifies client maintenance and centralizes computational load.

The user interacts with the system in a manner that leverages its technical advantages. The user does not need to know, or manually adapt to, each individual target apparatus interface. The user simply inputs a natural language prompt sentence. The system then provides a consolidated explanation of success or failure, with reduced delay and greater accuracy compared with a system that uses a rule-based parser and manual configuration of each target apparatus. The user benefits from fewer rejection cycles and clearer guidance when re-submitting applications.

In variants of this embodiment, the server may employ different types of generative AI models. In one variant, the server uses a sequence-to-sequence model with encoder-decoder architecture. The encoder converts token sequences of the prompt sentence into context vectors, and the decoder generates structured output under control of an attention mechanism. In another variant, the server uses a hybrid approach where a classification network identifies target apparatus categories and a generative model produces formatted structured text.

The server can also vary the storage structure for configuration data. In one variation, the server maintains configuration in a key-value store, using hash functions to map target names to configuration entries. In another variation, the server uses a graph database to represent relationships between information processing apparatuses, allowing the server to infer related targets for multi-apparatus operations.

The terminal may vary by platform. In some embodiments, the terminal is a desktop computer executing a web browser. In other embodiments, the terminal is a mobile device executing a native application. In all cases, the terminal presents an interface for the user to input a prompt sentence and displays explanation texts received from the server.

By implementing these embodiments, the system provides a specific technical solution to the problem of managing multi-apparatus applications via natural language interfaces. The server, terminal, and user act cooperatively to realize an end-to-end system in which generative AI model capabilities are integrated into deterministic control logic, structured data flows, and optimized communication patterns, resulting in improved speed, precision, resource utilization, and robustness of computer operations.

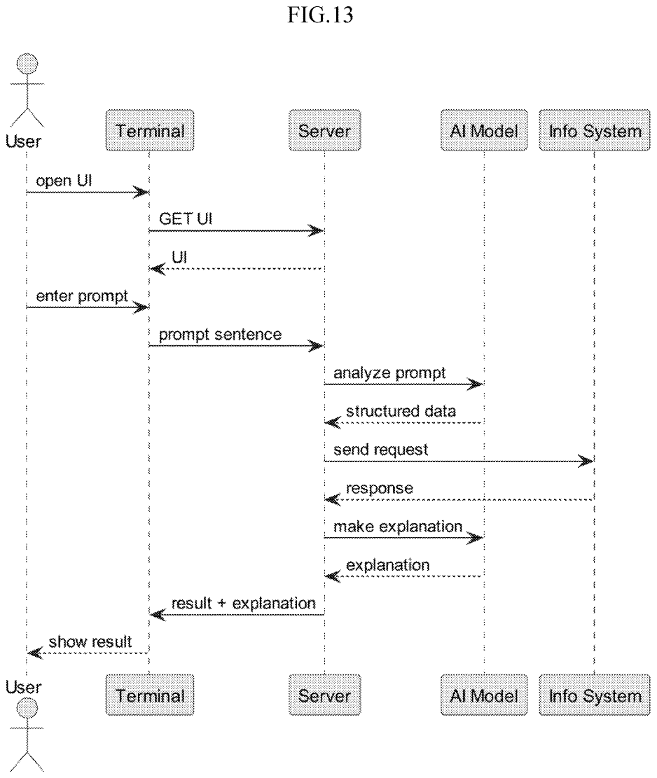

The following describes the processing flow using FIG. 13.

### Step 1:

The user operates the terminal to access a user interface provided by the server. The user opens a client application or web browser on the terminal and navigates to a URL of the system. The terminal sends a request to the server and receives an interface containing at least one text field for a prompt sentence and optional fields for user identification. The input of this step is a user action to access the system; the output is a rendered interface on the terminal that can accept a prompt sentence as input.

### Step 2:

The user inputs a prompt sentence in natural language into the interface displayed on the terminal. The user may input, for example, “I want to apply for read-only access to the customer data processing system for my account user_1234 starting from next Monday” or “Please submit applications so that I can access both the sales analysis system and the inventory management system with standard user privileges.” The terminal receives the prompt sentence as a character string, associates it with a user identifier and a session identifier, and prepares a data structure for transmission. The input of this step is raw text entered by the user; the output is a structured client-side object containing the prompt sentence and associated metadata ready to be sent to the server.

### Step 3:

The terminal transmits the structured client-side object to the server over a network. The terminal encodes the prompt sentence and metadata into a request message, attaches session information or authentication tokens, and sends the message via a communication protocol to the server. The input of this step is the prompt sentence object in the terminal's memory; the output is a network request delivered to the server that carries the prompt sentence and metadata as digital data.

### Step 4:

The server receives the network request containing the prompt sentence and metadata. The server decodes the request, verifies authentication information, and stores the received data in a temporary buffer in system memory. The server performs initial validation, such as checking that the prompt sentence is not empty and that the user identifier is present. The input of this step is the received network request; the output is a validated internal data structure that includes the prompt sentence, a user identifier, a timestamp, and a request identifier.

### Step 5:

The server invokes a pre-processing routine on the prompt sentence. The server converts the character sequence into tokens using a tokenizer compatible with the generative AI model, normalizes case or punctuation if necessary, and may compute basic statistics such as length or presence of specific keywords. The input of this step is the raw prompt sentence string in the internal data structure; the output is a tokenized and normalized representation of the prompt sentence, along with optional feature data, stored in memory for further analysis.

### Step 6:

The server constructs an analysis request for a generative AI model. The server builds a control instruction that specifies an extraction task, such as “identify target systems, requested authority types, user identifiers, and relevant time information,” and embeds the prompt sentence or its tokenized form into this instruction. The input of this step is the tokenized prompt sentence and system-side configuration of extraction requirements; the output is a model input structure that includes both the control instruction and the user prompt sentence prepared for submission to the generative AI model.

### Step 7:

The server sends the analysis request to the generative AI model and obtains a structured output. The server transmits the model input structure to a model execution environment and causes the generative AI model, which may be implemented as a transformer-based neural network, to compute an output sequence. Internally, the model applies embedding, attention, and feed-forward transformations to the tokenized prompt sentence and control tokens, and predicts output tokens that encode structured information. The input of this step is the model input structure; the output is a model output sequence that, when parsed, yields structured information such as target apparatus names, requested authority types, user identifiers, and time constraints.

### Step 8:

The server parses the model output sequence into structured information conforming to a predefined schema. The server scans the output tokens, identifies delimiters or field markers defined by the schema, and assigns extracted values to fields such as “application targets,” “authority type,” “user identifier,” and “time period.” If necessary, the server converts textual labels into standardized codes stored in a lookup table. The input of this step is the raw model output sequence; the output is a structured information object held in memory, representing semantic attributes extracted from the prompt sentence.

### Step 9:

The server accesses configuration data to map application targets to specific information processing apparatuses and communication interfaces. The server uses the names or codes in the structured information object as query keys, searches a configuration store for matching entries, and resolves potential synonyms through similarity comparison or secondary mapping tables. The server obtains, for each application target, endpoint information, protocol specifications, and authentication requirements. The input of this step is the structured information object derived from the prompt sentence; the output is a list of target apparatus configurations, each including an apparatus identifier and a corresponding communication interface specification.

### Step 10:

The server generates apparatus-specific request payloads by combining structured information with configuration data. The server selects a request template for each apparatus, fills the template fields with values such as the user identifier, authority code, and time period, and applies apparatus-specific formatting rules, for example converting natural language dates into machine-readable date values. The server attaches authentication and authorization information obtained from an authentication service or generated locally. The input of this step is the list of apparatus configurations and the structured information object; the output is a set of communication data payloads, each formatted according to the requirements of a particular information processing apparatus.

### Step 11:

The server transmits the apparatus-specific communication data payloads to corresponding information processing apparatuses. The server opens network connections, assigns appropriate protocols and headers, and sends each payload to the correct communication interface. The server also sets timeouts and retry policies based on configuration data. The input of this step is the set of prepared communication data payloads; the output is outbound network transactions that deliver the application content to each information processing apparatus.

### Step 12:

The server receives response data from the information processing apparatuses. Each apparatus returns a response that may include status codes, request identifiers, error descriptions, or approval details. The server collects the responses, decodes the protocol-level packaging, and extracts the message bodies. The input of this step is incoming network responses; the output is a set of parsed response objects in the server's memory, each linked to a corresponding apparatus and original request.

### Step 13:

The server normalizes the parsed response objects into a unified result structure. The server maps apparatus-specific status codes and fields to standardized categories such as “approved,” “rejected,” or “pending,” and stores identification information such as request IDs in designated fields. The server aggregates multiple response objects into a single composite result object indexed by apparatus or target name. The input of this step is the set of parsed response objects; the output is normalized result information that uniformly represents application results, identification information, and error information across all involved apparatuses.

### Step 14:

The server evaluates the normalized result information and prepares control instructions for explanation generation. The server may compute summary indicators, such as the total number of successful applications and the presence of any critical errors. The server then constructs a second prompt sentence for the generative AI model, which includes instructions such as “summarize each result in language understandable by the user and provide guidance for any failed applications,” and embeds the normalized result information in a structured form. The input of this step is the normalized result information and system policies for explanation level; the output is an explanation request structure destined for the generative AI model.

### Step 15:

The server sends the explanation request structure to the generative AI model and receives an explanation text. The server transmits the control instructions and embedded result data to the model, which applies its internal neural network operations to generate a coherent natural language explanation. The explanation may include sentences such as “Your read-only access to the customer data processing system has been approved” or “Your application to the inventory management system was rejected because the specified role is not available.” The input of this step is the explanation request structure containing normalized results; the output is an explanation text in natural language suitable for presentation to the user.

### Step 16:

The server optionally performs emotional state evaluation using the prompt sentence and user attributes. The server extracts lexical and structural features from the original prompt sentence, such as the use of strong emphasis terms or exclamation marks, and combines these with stored user profile attributes. The server provides these features to a classifier or to a specialized generative AI model prompt and obtains an estimated emotional state category. The input of this step is the original prompt sentence, related feature data, and user attributes; the output is an emotional state estimation that can be used to adjust prioritization and explanation style.

### Step 17:

The server adapts the explanation text and presentation ordering based on the emotional state estimation and normalized result information. The server may re-order sections of the explanation so that key success information appears first for stressed users, or may reduce technical jargon. The server edits or regenerates the explanation by modifying control parameters in the explanation request or by performing server-side post-processing on the generated text. The input of this step is the initial explanation text and emotional state estimation; the output is a final explanation text and presentation order optimized for the user's condition and the nature of the results.

### Step 18:

The server transmits the final explanation text and any associated structured result data to the terminal. The server packages the explanation, along with identifiers and status summaries, into a response message and sends it across the network. The terminal receives this response, decodes it, and renders the explanation text on the display device, optionally highlighting important messages. The input of this step is the final explanation text and normalized result information at the server; the output is a displayed message on the terminal that informs the user of application results and guidance.

### Step 19:

The server stores the structured information and normalized result information in a database for later retrieval and analysis. The server writes records that link the original prompt sentence, the extracted structured attributes, the target apparatuses, and the final outcomes. The server may also log model outputs and emotional state estimations for monitoring and improvement of the system. The input of this step is the structured information object and normalized result information generated in previous steps; the output is persistent records in one or more database tables that support subsequent queries, audits, and performance optimization.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that support user applications, such as change requests, security configuration requests, and electronic transaction requests, typically require users to manually enter data into rigid forms that are tightly coupled to specific back-end data schemas and workflows. These systems generally treat user input as already structured data and are not designed to reliably interpret free-form natural language, to understand user emotional state, or to adapt the downstream processing and prioritization logic accordingly. As a result, multiple technical problems arise in the field of computer-implemented application processing.
First, when users provide application content in natural language, existing systems either reject such input or use simplistic keyword matching. Keyword-based approaches are brittle, often fail to capture context and intent, and cannot robustly map heterogeneous language expressions to normalized data structures that back-end databases and external systems require. This leads to frequent operator intervention, manual re-entry of data, and non-deterministic mapping rules embedded in application code, which increases processing latency, consumes computational resources inefficiently, and makes the system difficult to maintain or scale.
Second, even when systems incorporate machine learning components, they usually apply fixed models or static rules without an explicit and controllable prompt interface. Known systems do not systematically generate and manage prompt sentences for a generative AI model as a first-class control mechanism. Without such prompt-level control, it is difficult to dynamically adapt the model's extraction behavior, target schema, or optimization criteria based on run-time context, such as the detected application type or the current workload. This limits the ability of the computer system to flexibly repurpose a single generative AI model for multiple heterogeneous workflows in a predictable and auditable manner.
Third, typical systems do not integrate user emotion analysis into the core data processing pipeline. Emotion information, if used at all, is handled as an auxiliary UI feature rather than as a parameter that affects structured data generation, workflow selection, and processing priority. As a consequence, the system cannot adjust its internal scheduling, routing, or content optimization logic according to the user's emotional state. The lack of such integration leads to inefficient resource allocation, sub-optimal prioritization of urgent or stress-inducing requests, and an inability to systematically generate application content proposals that are tailored to the user's emotional context.
Fourth, conventional architectures are not designed to classify and route free-form user input across multiple categories of back-end workflows, such as security-related workflows, settlement-related workflows, and operational-change-related workflows, using a unified generative AI component. Routing is usually implemented through hard-coded conditional logic or static configuration, which cannot easily accommodate new categories or evolving schemas without extensive code changes and database migrations. This rigidity hampers the scalability and extensibility of the computer system and increases the likelihood of inconsistent behavior across different application types.

Therefore, there is a need for an improved computer-implemented system that: (i) receives and processes user applications expressed in natural language, (ii) converts such unstructured inputs into structured, schema-compatible records using a generative AI model under explicit prompt control, (iii) integrates emotion state information into prompt generation, workflow selection, and priority determination, and (iv) flexibly routes and executes multiple types of application workflows in external information processing apparatuses, thereby improving the technical functioning of the computer system as a whole.

The specific processing by the specific processing unit 290 of the data processing device 12 in Application Example 2 is realized by the following means.

The present invention provides a server comprising a processor configured to provide, to a terminal, a user interface that accepts user information including application content and emotion-bearing expressions in natural language, and to receive such information via a communication channel; to generate, for each received natural language input, at least one prompt sentence that explicitly specifies a target data structure and an extraction or optimization task, to supply the generative AI model with combined input including the prompt sentence and the natural language data, and to obtain analysis result data including structured information such as an application type, field names, and field values; to map the structured information to a normalized data structure corresponding to the determined application type, to record the mapped information in a data storage apparatus for application management, and to convert the mapped information into a format suitable for invocation of at least one external information processing apparatus; to obtain emotion state information from an emotion analysis component based on the user input, to generate prompt sentences that cause the generative AI model to produce application content candidates taking into account the emotion state, and to acquire candidate information representing emotion-aware application proposals from the generative AI model; to transmit the candidate information to the terminal for user approval, to receive approval information from the terminal, to record approved candidates as final application information in the data storage apparatus, and to output control information instructing execution of corresponding application processes by the external information processing apparatus; and to select, on the basis of the analysis result data and the emotion state information, one among a plurality of workflow types including security-related workflows, settlement-related workflows, and operational-change-related workflows, and to generate and adapt prompt sentences such that the generative AI model classifies the input and produces data structures compatible with the selected workflow. This enables the computer-implemented system to automatically transform heterogeneous natural-language and emotion-laden user inputs into structured, workflow-specific data, to dynamically route and prioritize multiple categories of application processing based on both semantic content and emotion state, and to interact with diverse external systems using unified, prompt-driven generative AI control, thereby improving the efficiency, scalability, and flexibility of the underlying computer technology.
The term “system” refers to a combination of hardware and software components that cooperate to perform information processing, including at least one processor, at least one data storage apparatus, and at least one communication interface.
The term “processor” refers to a hardware processing unit, such as a central processing unit or a programmable controller, that executes instructions to perform operations including input reception, data analysis, prompt generation, workflow control, and communication with external apparatuses.
The term “terminal” refers to an information input/output apparatus, such as a user device equipped with a display and an input interface, that exchanges data with the server via a communication network and provides a user interface for presenting information and receiving user input.
The term “user interface” refers to a software-implemented interaction mechanism, such as graphical screens, forms, or dialog windows, through which a user views information and inputs data including natural language text and selections.
The term “natural language data” refers to character data or text strings expressed in a human language, such as sentences or phrases describing application content or user feelings, that have not yet been converted into a structured format.
The term “emotion-bearing expression” refers to a part of the natural language data that conveys or implies a user's emotional state, such as stress, anxiety, joy, or dissatisfaction.
The term “communication channel” refers to a logical or physical path, established over a communication network, that enables the exchange of data messages between the terminal and the server using a communication protocol.
The term “generative AI model” refers to a machine-implemented data processing model, based on techniques such as neural networks or transformer architectures, that generates or transforms information in response to one or more input sequences, including prompt sentences and natural language data.
The term “prompt sentence” refers to a control instruction sequence represented as text that specifies to the generative AI model a processing objective, a target data format, or conditions for generating or analyzing output.
The term “analysis result data” refers to data output from the generative AI model that represents at least one interpretation of the input natural language data, including extracted entities, classifications, or transformed representations.
The term “structured information” refers to data organized according to a predefined schema, such as key-value pairs or table fields, that can be directly stored in a database or used by workflow logic.
The term “application type” refers to a category assigned to an application, such as a security-related application, a settlement-related application, or an operational-change-related application, that determines a corresponding data schema and workflow.
The term “item name” refers to an identifier of a data field, such as a label or key, that represents a semantic attribute within an application record.
The term “item value” refers to a content value associated with an item name, representing a specific piece of information in an application record, such as a date, an identifier, or a descriptive text.
The term “data storage apparatus” refers to a hardware and software subsystem, such as a database server or persistent storage device, that stores and manages records related to applications, prompt calls, analysis results, and workflow states.
The term “data structure” refers to an arrangement of data elements according to a predefined format, such as records, objects, or tables, enabling efficient access, storage, and manipulation.
The term “normalized data structure” refers to a data structure whose fields and relationships are organized according to design constraints that reduce redundancy and enable consistent representation across multiple application types.
The term “application management” refers to processing operations for storing, updating, retrieving, and tracking application information throughout its lifecycle, including submission, approval, execution, and completion.
The term “external information processing apparatus” refers to a separate computing system, such as a service platform or back-end system, that receives structured requests and executes domain-specific processing related to applications.
The term “emotion state information” refers to data describing an estimated emotional condition of a user, such as stress level or satisfaction, obtained from an emotion analysis process.
The term “emotion analysis apparatus” refers to a subsystem, which may include software models or external services, that receives user-related data such as text or images and outputs an evaluation of the user's emotional state.
The term “application content candidate” refers to proposed application data generated by the generative AI model, which is not yet finalized, and which may be presented to the user for confirmation or modification.
The term “application content candidate information” refers to structured representation of one or more application content candidates, including fields, descriptions, and associated metadata.
The term “final application information” refers to application data that has been approved by the user or determined by the system as confirmed and is ready to be recorded, transmitted, and executed in a workflow.
The term “control information” refers to command data or parameters prepared by the processor for instructing the external information processing apparatus to execute a specific application-related operation.
The term “workflow type” refers to a class of processing steps for handling an application, including at least security-related workflows, settlement-related workflows, and operational-change-related workflows, each associated with specific rules and target systems.
The term “security-related process” refers to a workflow type relating to protection of information resources, including operations such as policy changes, access control adjustments, or logging configuration.
The term “settlement-related process” refers to a workflow type relating to financial or transactional operations, including operations such as payment processing, cancellation, or fee adjustments.
The term “operational-change-related process” refers to a workflow type relating to modification of operational conditions in an organization, including operations such as resource allocation changes or configuration updates of services.
The term “workflow processing” refers to execution of a sequence of operations defined for a particular workflow type, including validation, recording, external system invocation, and status updating.
The term “classification result” refers to data indicating a category or type determined for an input, such as an application type, based on analysis by the generative AI model or other processing logic.
The term “natural language processing technique” refers to a computational method for analyzing human language data, including operations such as tokenization, part-of-speech tagging, entity recognition, and intent detection.
The term “tokenization” refers to a process of segmenting a sequence of characters or words in natural language data into discrete units called tokens for subsequent analysis.
The term “important terms” refers to tokens or word sequences identified as having particular relevance or weight for understanding or classifying the natural language data in the context of application processing.
The term “entities” refers to semantic units such as names, identifiers, dates, or amounts that are extracted from natural language data as distinct, typed information items.
The term “intent information” refers to data representing an inferred purpose or goal expressed by the user in the natural language data, such as requesting a change, cancellation, or approval.
The term “application category” refers to a grouping of applications based on similar intent or processing requirements, which is used to select specific schemas and workflow logic.
The term “related information processing function” refers to a functional module or service that is part of the system or an external apparatus and is responsible for handling applications belonging to a particular category.
The term “importance” refers to a degree measure indicating how critical or significant particular application information is, determined based on content and emotion state.
The term “processing priority” refers to an order parameter indicating a relative urgency or scheduling preference for processing an application within the system.
The term “optimization processing of the application content” refers to computation that adapts, restructures, or refines application data to better satisfy criteria such as clarity, completeness, or suitability for automatic execution.
The term “optimized application information” refers to application data that has been processed to satisfy one or more optimization criteria and is used for recording and for instructing external systems.
The term “approval information” refers to data indicating a user's decision to accept, confirm, or reject application content candidates or proposals presented by the system.

In one embodiment, a server, a terminal, and a communication network together implement the claimed system. The server includes at least one processor, a non-transitory storage medium storing programs and models, and a communication interface connected to a network such as an IP-based network. The terminal includes at least one processor, a display, an input device such as a touchscreen or keyboard, a camera and/or microphone, and a communication interface. The server executes software components including a Web application module, an API gateway, a workflow engine, a database management module, an emotion analysis client, and a generative AI client. The terminal executes a native application or Web browser that presents user interfaces and exchanges messages with the server via HTTPS.

The server executes an operating system such as a generic server operating system, and a web or application framework such as a generic HTTP server framework or application framework. The server executes a database management system such as a relational database engine or a document database engine as the data storage apparatus. The server stores application records, AI call logs, emotion analysis results, and workflow state data in one or more databases. The terminal executes a mobile operating system or desktop operating system and uses native UI toolkits or browser technologies to render application screens.

The server configures a generative AI model as the core analysis engine. In one embodiment, the generative AI model is a transformer-based neural network with multiple encoder-decoder layers, multi-head self-attention mechanisms, and positional encoding, similar to known sequence-to-sequence architectures. The server deploys this generative AI model either as a local model implemented using a machine learning framework such as a generic tensor computation framework, or as a remote model accessed through an API provided by a generative AI service. The model parameters are stored in a model repository and loaded into memory by a model inference engine on the server.

The server trains the generative AI model on a corpus of historical application texts and their corresponding structured records. The server uses tokenized natural language input sequences as inputs and target JSON-like field sequences as outputs during supervised learning. The server uses an objective function such as cross-entropy loss between predicted token distributions and ground-truth tokens, and the server updates the model's weights using gradient-based optimization such as stochastic gradient descent or Adam. The server applies data augmentation techniques such as synonym replacement, paraphrasing, and random masking to increase robustness of the model. The server stores the final trained weights and related hyperparameters (for example, number of layers, hidden size, number of attention heads, learning rate) in configuration files.

The server uses the generative AI model in inference mode to process user-supplied natural language data. The server represents the natural language data as token sequences using a tokenizer, such as a byte-pair encoding or wordpiece tokenizer. The server also represents each prompt sentence as a sequence of tokens. The server concatenates the prompt sentence tokens and user text tokens into a single input sequence with special delimiter tokens, and the server feeds this sequence into the transformer network. The model computes attention scores and hidden states across the sequence and outputs probability distributions over vocabulary tokens at each position. The server decodes these distributions using beam search or greedy decoding to obtain an output string. The server then parses the output string into structured key-value pairs according to the format specified in the prompt sentence.

The server generates different prompt sentences according to context. For example, the server may generate a prompt sentence for change request extraction such as:
“Analyze the following CR application text and extract the project name, change type, requested date, and reason. Output each item as plain text with labels: ‘Project name:’, ‘Change type:’, ‘Requested date:’, and ‘Reason:’.”

The server may generate a prompt sentence for electronic transaction handling such as:
“Analyze the following electronic transaction request, and extract the payment ID and the cancellation reason. Provide the result as labeled lines starting with ‘Payment ID:’ and ‘Cancellation reason:’.”

The server may generate a prompt sentence for emotion-aware proposal generation such as: “The user is experiencing work-related stress according to emotion analysis. Propose one or two types of internal applications, such as refresh leave or workload adjustment, that could help reduce stress. Provide each proposal as a short title and one-sentence description.”

The server uses these prompt sentences as control instructions that explicitly direct the generative AI model to produce outputs aligned with a desired schema and task. This prompt-level control is non-conventional compared to static text classification or rule-based extraction because the server dynamically modifies the prompt structure, labels, and target fields in response to user emotion and application context.

The server configures an emotion analysis apparatus to estimate user emotion states. In one embodiment, the emotion analysis apparatus is an external emotion recognition API that receives text or image data and returns emotion labels and scores. The server sends user text to a text-based sentiment analysis service, which uses its own neural network model to output scores for categories such as positive, negative, stress, or anxiety. The server also sends face images or video frames captured by the terminal's camera to an image-based emotion recognition service, which uses a convolutional neural network to output probabilities for emotions such as joy, anger, fear, and sadness. The server receives these scores as numerical vectors and combines them by weighted averaging or rule-based fusion to obtain a single dominant emotion label and confidence score. The server then stores the emotion state information in a dedicated table in the database.

The server uses the emotion state information as an input feature when constructing prompt sentences for the generative AI model. The server, for example, appends a phrase describing the emotion state in the prompt, such as “The user is feeling anxiety,” or changes the optimization criterion, such as “propose an application that reduces stress.” By explicitly encoding emotion as part of the prompt, the server causes the generative AI model to produce application content candidates that differ from candidates generated under neutral or joyful emotional states. This technique modifies the distribution of generated outputs in a controlled manner, which leads to technical improvements in personalization and relevance of generated data.

The server integrates the generative AI client and the emotion analysis client in a workflow engine. The workflow engine is implemented as a software module that receives input events from the API gateway, executes rule graphs or state machines, calls external services, and updates database records. The workflow engine includes routing logic that determines an application category, such as security-related, settlement-related, or operational-change-related, based on the structured outputs of the generative AI model. For instance, when the structured output contains fields such as “payment ID” and “cancellation reason,” the workflow engine classifies the application as settlement-related. When the structured output contains fields such as “policy name,” “scope,” and “security level,” the workflow engine classifies the application as security-related.

The server stores classification rules and schema definitions in configuration tables. Each application category is associated with a target schema, the required external information processing apparatus, and a specific set of validation rules. The server uses these configurations to map the model's structured outputs to normalized database tables, such as separate tables for security policy requests, payment cancellation requests, and resource change requests. By mapping heterogeneous natural language to unified data structures in this way, the server reduces schema mismatch errors and simplifies downstream validation and execution code. This directly improves internal data management and reduces the need for custom parsing logic.

The terminal presents user interfaces that guide the user through the process. The terminal displays input fields where the user types natural language application content, such as:
“I want to apply for a CR for a new project. The project name is Alpha.” or
“I want to cancel the payment with ID 98765 because it was charged twice.”

The terminal sends these texts to the server over HTTPS, together with metadata such as user identity and selected application mode. The terminal also captures user facial images or voice if the user permits emotion analysis and sends that data to the server. The terminal updates its user interface according to responses from the server, displaying structured information, suggested application content candidates, and final confirmation messages. The terminal may highlight fields generated by the generative AI model and allow the user to edit them before approval.

The user interacts with the terminal by entering natural language, reviewing the generated structured fields, and approving or rejecting proposals. The user does not manually map each sentence to database fields; instead, the user reviews AI-generated mapping results and candidates. This reduces cognitive load but, more importantly, allows the system to implement complex, non-linear mapping algorithms that would be difficult to perform manually.

The server uses specific data structures to manage the flow of information. For example, the server stores raw natural language input as records in a “raw_input” table with fields for user ID, timestamp, text body, and source channel. The server stores AI analysis calls in an “ai_calls” table with fields for input reference, prompt text, model version, output text, and error codes. The server stores structured application data in normalized tables such as “security_requests,” “payment_requests,” and “change_requests,” each with specific columns such as identifiers, dates, amounts, and reasons. The server references emotion state information by foreign keys from application tables to an “emotion_states” table. The server uses indices on these tables to accelerate queries for status dashboards and history retrieval.

The server improves computer technology in several ways. First, the server decreases processing latency and CPU load by centralizing the natural language understanding in a single generative AI model controlled via prompt sentences, rather than running multiple specialized parsers or rule sets for each application type. Because the server can modify prompt sentences instead of retraining or redeploying different models, the system reduces the overhead of model management and network communication. This leads to lower memory consumption and faster response times.
Second, the server increases accuracy and robustness of text-to-schema mapping by combining neural network inference with explicit prompt specifications and post-processing validation. The server uses non-conventional post-processing routines that compare AI-generated fields against schema constraints such as field types, regular expressions, and referential integrity rules. When the server detects inconsistencies, the server can regenerate outputs using modified prompt sentences or fallback templates. This iterative prompt and validation cycle is not a mere automation of human reading; it is a specific algorithmic procedure that exploits the generative nature of the model and the structure of database schemas to systematically reduce mapping errors.
Third, the server improves data management and reduces communication load with external systems. The server converts raw natural language into compact structured formats before sending requests to external information processing apparatuses. Instead of forwarding full user texts, the server sends only needed identifiers and field values, which reduces payload size and network bandwidth usage. The server also caches structured results and external system responses in local databases, enabling efficient retrieval of status information without repeatedly querying external systems.
Fourth, the server uses emotion state information not only as user context but as a control signal for the internal scheduling and routing of workflows. The server adjusts processing priorities based on emotion state, such that, for example, settlement-related requests associated with anxiety are processed with higher priority than routine configuration requests. This priority adjustment is executed at the level of the workflow engine's task queue and scheduler, which uses numerical priority values stored in database fields. The scheduler reorders tasks and allocates threads based on these values, leading to measurable improvements in response times for emotionally urgent tasks.

In another embodiment, the server implements the generative AI model locally using a tensor computation framework. The server constructs a transformer architecture with N encoder layers and M decoder layers, each with multi-head self-attention, layer normalization, and feed-forward sublayers. The server encodes token positions using sinusoidal positional encodings or learned embeddings. During training, the server minimizes a loss function such as cross-entropy while applying regularization methods such as dropout. The server stores model checkpoints and uses early stopping criteria to prevent overfitting. During inference, the server uses a decoding algorithm with constraints on maximum length, repetition penalty, and token type masks to enforce output structure, such as presence of labeled lines “Project name:” and “Change type:”. This architectural detail demonstrates that the claimed invention is rooted in specific improvements to the way a computer system represents and processes language data, not just an abstract business method.

In another embodiment, the server employs a hybrid rule-based and neural approach. The server defines a rule engine that inspects the AI-generated text and applies deterministically defined transformations. For example, if the AI output includes a line starting with “Payment ID:”, the rule engine extracts the trailing token sequence as a payment identifier and validates it against a checksum or pattern rule. If the output does not contain such a line, the server generates a modified prompt sentence emphasizing the missing field and re-invokes the model. This loop is an explicit, non-human style of interaction between rules and generative outputs, designed to reduce errors and improve stability of the system.

The server also supports alternative emotion analysis methods. In one alternative, the server deploys its own recurrent or transformer-based classifier for text emotion recognition. The server trains this classifier on labeled emotion datasets, using sentence embeddings as inputs and emotion labels as outputs. The server integrates the classifier into the workflow engine and uses its probability outputs as features for prompt construction and scheduling. In another alternative, the server uses only facial expression analysis, skipping text-based emotion analysis. The system remains within the claimed scope as long as emotion state information is acquired and propagated into prompt generation and workflow control.

The terminal may be implemented in different forms. In one implementation, the terminal is a smartphone running a native application that uses a camera and touchscreen. In another implementation, the terminal is a desktop computer running a browser that communicates with the server via a Web application. In all implementations, the terminal's role is limited to user interaction and basic input validation, while the heavy analysis, mapping, and workflow control occur on the server.

The user may operate the system in various domains, such as information security, financial services, or operations management. However, the technical contribution remains the same: the server uses a generative AI model with prompt sentences and emotion state information to transform unstructured, heterogeneous natural language and emotion-laden inputs into structured, workflow-specific data suitable for execution by external information processing apparatuses. The specific combinations of transformer-based generation, prompt-controlled extraction, emotion-driven prompt variation, normalized schema mapping, and workflow routing provide concrete improvements to computer-implemented information processing, including higher mapping accuracy, reduced latency, improved resource utilization, and lower communication overhead with external systems.

By providing these detailed implementations and variations, the system described herein allows a person skilled in the art to realize the claimed invention on standard computer hardware using known software components, while achieving the described technical effects in terms of processing speed, accuracy, robustness, and scalability of application processing in a networked computing environment.

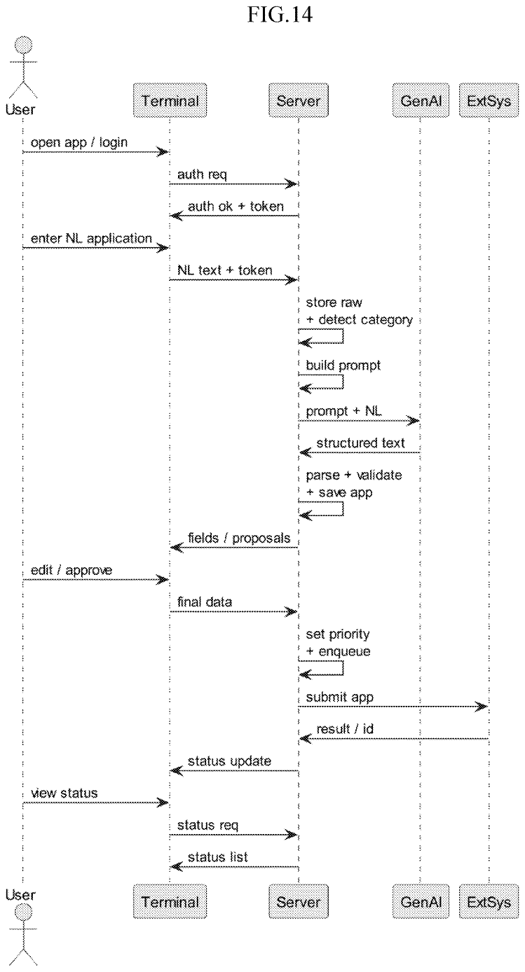

The following describes the processing flow using FIG. 14.

### Step 1:

The user starts the application on the terminal.

The terminal displays a login or home screen implemented using native UI components or browser UI.
Input: no prior data from the user (initial state).
Output: a UI state waiting for user credentials or a command to start a new application.

The terminal allocates UI widgets, binds event handlers, and initializes a local session state in memory so that subsequent user actions can be captured and sent to the server.

### Step 2:

The user inputs identification information and optionally selects an application mode (for example, “change request,” “security request,” or “transaction request”) on the terminal.

The terminal collects the user ID, password or token, and selected mode, and packages them into a message.
Input: user-provided credentials and mode selection.
Output: a structured request (for example, a JSON object) sent to the server via HTTPS.

The terminal performs basic validation (non-empty fields, format checks) and then calls a network library to transmit the request through a secure channel.

### Step 3:

The server receives the request and validates the user.

The server parses the incoming message, extracts the user ID and authentication data, and queries a user record in a database.
Input: authentication request from the terminal.

Output: an authentication result and an associated session token.

The server computes a hash of the received password, compares it with a stored hash using a cryptographic library, and, if valid, generates a session token, inserts or updates a session record in a session table, and returns the token to the terminal.

### Step 4:

The terminal stores the session token and presents an input interface for natural language application content.

The terminal writes the token into secure local storage and attaches it to headers for subsequent network requests.
Input: authentication result and session token from the server.
Output: an active authenticated session on the terminal and a visible text input area for application content.

The terminal changes its UI state to an editor screen and allocates memory buffers for the text that the user will enter.

### Step 5:

The user inputs application content and, optionally, an explanation of the situation or emotion in natural language on the terminal.

The terminal collects the text, the current application mode, and the session token.
Input: free-form natural language text from the user.
Output: a message containing the natural language text and metadata transmitted to the server.

The terminal may perform client-side spellchecking or length checks, then serializes the data (for example, into JSON) and sends it via HTTPS to an API endpoint of the server.

### Step 6:

The server receives the natural language input and stores a raw record.

The server verifies the session token, extracts user ID and mode, and inserts a new record into a raw input table in the database.
Input: natural language text and metadata from the terminal.
Output: a stored raw input record with an internal identifier and an in-memory representation for further processing.

The server assigns a unique ID to the input, writes user ID, timestamp, mode, and text body into the database using an insert operation, and returns the internal ID to the workflow engine.

### Step 7:

The server obtains emotion-related data and sends it to an emotion analysis apparatus.

The server takes the user text and, if available, associated audio or image references and constructs a request to an emotion analysis service.
Input: stored natural language text (and optional media references).
Output: an emotion analysis request transmitted to an external or internal emotion analysis component.

The server formats the text into the service's required payload structure, calls the emotion API over HTTP or via a local library, and waits for the emotion scores as response.

### Step 8:

The server receives emotion state information from the emotion analysis apparatus and stores it.

The server parses the response, which contains emotion labels and associated scores, and selects a dominant emotion.
Input: raw emotion analysis response (for example, scores for stress, joy, anxiety).
Output: a normalized emotion state record stored in an emotion_states table and a dominant emotion label in memory.

The server converts probability vectors into a single label (“stress,” “anxiety,” etc.) using a maximum or threshold rule and writes the label, scores, and raw input ID into the database.

### Step 9:

The server determines an application category based on the mode and content.

The server uses basic rules (selected mode) and simple natural language processing (for example, keyword detection or previous model outputs) to classify the request as security-related, settlement-related, or operational-change-related.
Input: raw natural language text, mode metadata, and possibly emotion label.
Output: an application category used for choosing a target schema and prompt strategy.

The server checks the mode first; if ambiguous, the server runs a lightweight classifier that counts category-specific terms and chooses the category with highest score, then saves this category in memory and, optionally, in a classification table.

### Step 10:

The server constructs a task-specific prompt sentence for the generative AI model.

The server selects a prompt template based on the application category and detected emotion, and fills the template with category-specific field names and possibly emotion context.
Input: application category, dominant emotion, and configuration of target fields.
Output: a concrete prompt sentence instructing the generative AI model.

The server reads a prompt template such as “Analyze the following CR application text and extract the project name, change type, requested date, and reason. Output each item as plain text with labels: ‘Project name:’, ‘Change type:’, ‘Requested date:’, and ‘Reason:’.”

The server modifies the prompt if the emotion is “stress,” for example, by appending “Take into account that the user is feeling stressed and ensure that the reason is clearly expressed.” Then the server stores the final prompt text in an AI call log buffer.

### Step 11:

The server tokenizes the prompt sentence and the user text and prepares an input sequence for the generative AI model.

The server passes the concatenated prompt and user text through a tokenizer that maps text into token IDs and positional indices.
Input: prompt sentence text and user natural language text.
Output: a tokenized sequence suitable for transformer-based inference.

The server inserts special tokens (for example, start-of-prompt, separator, end-of-input) and builds an array of token IDs and position indices, which the model inference engine stores in its input buffers.

### Step 12:

The server executes inference of the generative AI model to obtain structured output text.

The server runs the token sequence through the generative AI model, computing self-attention and feed-forward transformations layer by layer.
Input: tokenized sequence and model parameters stored in memory.
Output: an output token sequence representing structured textual output from the generative AI model.

The server calculates attention weights and hidden states using matrix multiplications, applies activation functions and layer normalization, and decodes the output sequence by selecting the most probable token at each step using greedy or beam search decoding.

### Step 13:

The server decodes the model output into structured fields.

The server converts the output token sequence to text and parses lines based on labels mandated by the prompt, such as “Project name: . . . ” and “Change type: . . . ”.
Input: generated textual output from the generative AI model.
Output: a set of key-value pairs representing extracted fields.

The server splits the output by line breaks, identifies lines beginning with known labels, strips the labels, and maps the remaining portions to internal field names, storing these key-value pairs in a temporary structure such as a dictionary in memory.

### Step 14:

The server validates the structured fields against schema definitions.

The server checks field types, required fields, and constraints based on the selected application category's schema.
Input: key-value pairs representing fields and the target schema specification.
Output: either a validated structured record or an error condition requiring regeneration or correction.

The server verifies that date fields conform to date formats, identifiers match regular expressions, and required fields are present; if any check fails, the server records an error code and either adjusts the prompt or marks the field for user correction.

### Step 15:

The server maps the validated fields into normalized database structures and records an application entry.

The server selects the appropriate database table, constructs a record with normalized columns, and executes an insert operation.
Input: validated structured fields and a target table name.
Output: a new row in the database with a unique application ID and a stored normalized record.

The server translates human-readable field values into canonical internal formats (for example, mapping category labels to integer codes), executes an insert query via the database management system, and receives confirmation of successful persistence.

### Step 16:

The server generates one or more emotion-aware application content candidates, if applicable.

The server uses the emotion state and initial structured fields to construct an additional prompt sentence for proposal generation.
Input: emotion label, structured fields, and optional organization policy parameters.
Output: one or more application content candidates represented as text (titles and descriptions) from the generative AI model.

The server creates a prompt sentence such as “The user is experiencing work-related stress according to emotion analysis. Propose one or two types of internal applications, such as refresh leave or workload adjustment, that could help reduce stress. Provide each proposal as a short title and one-sentence description.” and sends this, together with context text, to the generative AI model as in previous steps to obtain candidate descriptions, which the server parses into candidate records.

### Step 17:

The server stores the application content candidates and returns them to the terminal.

The server inserts candidate records into a proposal table linked to the original application and emotion state, then formats them for presentation.
Input: parsed candidate titles and descriptions.
Output: database records of proposals and a response message containing proposals for the terminal.

The server writes each candidate (title, description, related application ID) into the database and constructs a response payload listing the candidates in a structure suitable for the terminal's UI.

### Step 18:

The terminal receives the structured fields and any proposals and displays them to the user.

The terminal builds a screen showing extracted fields in editable form fields and candidate application proposals as selectable items.
Input: structured field data and candidate proposals from the server.
Output: a rendered user interface allowing review, editing, and selection.

The terminal parses the response, populates text fields with the extracted values, creates UI components for each proposal (such as cards with title and description), and waits for user interaction.

### Step 19:

The user reviews the structured fields and proposals and either edits or approves them on the terminal.

The user may modify any automatically generated values, select one proposal or none, and press an “Approve” or “Submit” button.
Input: displayed structured data and proposals.
Output: user decisions and any modified values entered into the terminal.

The terminal captures field edits and which proposals were selected or rejected, and prepares an approval message containing the final field values and chosen proposal identifiers.

### Step 20:

The terminal sends the approval message and finalized data to the server.

The terminal uses the active session token and network stack to transmit the approval content.
Input: user-approved fields and selected proposals.
Output: an approval request message received by the server.

The terminal serializes the data, attaches headers, and sends it to the server's approval endpoint, then waits for a confirmation response.

### Step 21:

The server updates the application record with the final data and calculates processing priority.

The server merges user edits with previously stored fields and computes priority based on emotion state and application type.
Input: approval request containing updated field values and selected proposal IDs.
Output: an updated application record and a computed priority value stored in the database.

The server overwrites editable fields in the main application table, calculates a numeric priority score using a function of emotion label (for example, higher multiplier for “anxiety”) and application type, and writes this priority into a priority column.

### Step 22:

The server enqueues the application into a workflow queue with the computed priority.

The server creates a workflow task record that references the application ID, category, and priority, and inserts it into a workflow queue table or an in-memory priority queue.
Input: updated application ID and priority value.
Output: a workflow task scheduled for execution by the workflow engine.

The server writes a task entry with fields for status, next action, and priority; if using an in-memory scheduler, the server inserts the task into a heap or sorted list keyed by priority.

### Step 23:

The server selects a workflow type and prepares an external request to an external information processing apparatus.

The server reads the application category and table mapping, determines the appropriate external system, and constructs an external request message.
Input: workflow task, category label, and normalized application record.
Output: a formatted request body suitable for the external apparatus (for example, a JSON document or structured message).

The server transforms internal field names and codes into the external system's expected field names and formats, builds a request payload including identifiers, amounts, and reasons, and selects the correct endpoint URL from configuration.

### Step 24:

The server transmits the external request and records the response.

The server calls the external system's API using an HTTP client library or other protocol, and stores the external system's response.
Input: prepared request body and endpoint information.
Output: an external system response and corresponding log entry in the database.

The server sends the request, waits for a reply (for example, containing an external ticket ID or status), parses the response, and inserts a record into an external_call log table with request, response, and status fields.

### Step 25:

The server updates the application and workflow status based on the external response.

The server writes the external ticket ID and new status into the main application table and marks the workflow task as completed or transitioned to the next step.
Input: external response data (ticket IDs, status codes).
Output: updated application status and workflow task state in the database.

The server sets fields such as “external_id,” “status =submitted” or “status =completed,” and updates the workflow task row to reflect completion or waiting state for further events.

### Step 26:

The server sends a completion or status update message to the terminal.

The server creates a concise representation of the new status, including key identifiers and user-relevant information.
Input: updated application record and status codes.
Output: a notification message containing status details for the terminal.

The server constructs a message such as “Your change request has been submitted. External ticket ID: CR-12345,” and transmits it to the terminal via the established session.

### Step 27:

The terminal displays the status update and optionally stores a local summary.

The terminal shows a confirmation message and may add the application to a local “history” or “status” view.
Input: status update message from the server.
Output: a visual indication on the user's screen and an updated local list of applications.

The terminal parses the message, updates UI elements (such as a list item status indicator), and presents a notification banner or dialog to the user.

### Step 28:

The user may subsequently request an overview of all applications on the terminal.

The terminal sends a status retrieval request, including the session token and optional filters (such as time period or category), to the server.
Input: user request to view status and filter parameters.
Output: a status query message sent to the server.

The terminal constructs a simple query payload and sends it via HTTPS to the server's status endpoint.

### Step 29:

The server aggregates application statuses and returns a consolidated status list.

The server queries multiple application tables and joins them with workflow and external call logs to construct a unified view.
Input: status query, user ID, and optional filter conditions.
Output: a list of status entries grouped by application type and ordered by time or priority.

The server executes database queries that filter records by user ID and filter conditions, aggregates important fields (IDs, types, statuses, timestamps), builds a structured list in memory, and sends it to the terminal.

### Step 30:

The terminal renders the consolidated status list for the user.

The terminal takes the received list and displays it as a scrollable view with labels for type, status, and last update time.
Input: consolidated status list from the server.
Output: a visible dashboard of application statuses on the terminal.

The terminal creates list items for each record, assigns icons and colors based on category and status, and allows the user to tap an item to see underlying details, including the original natural language text and extracted fields.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

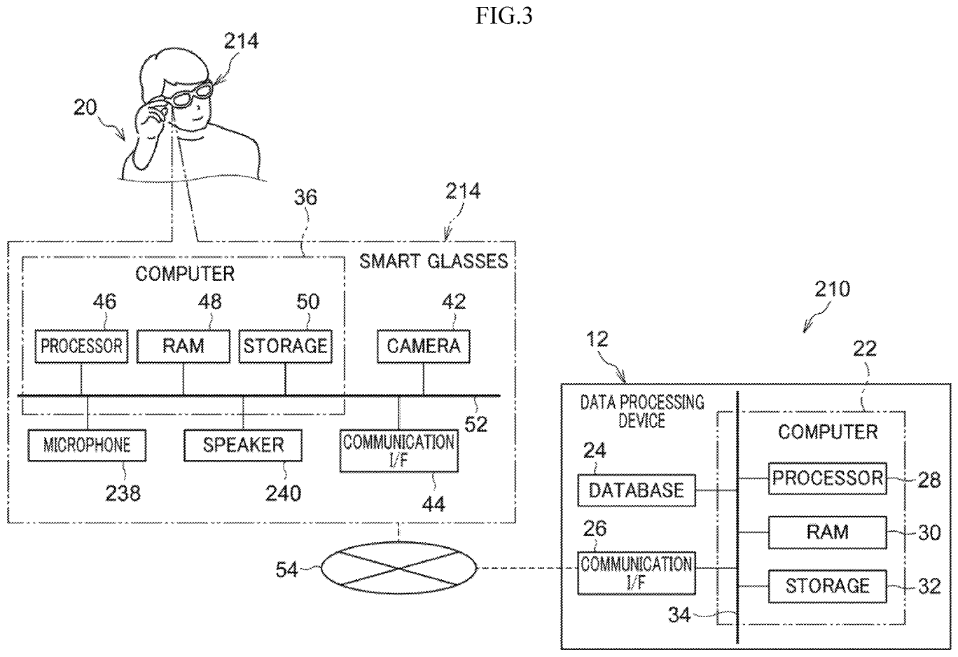

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

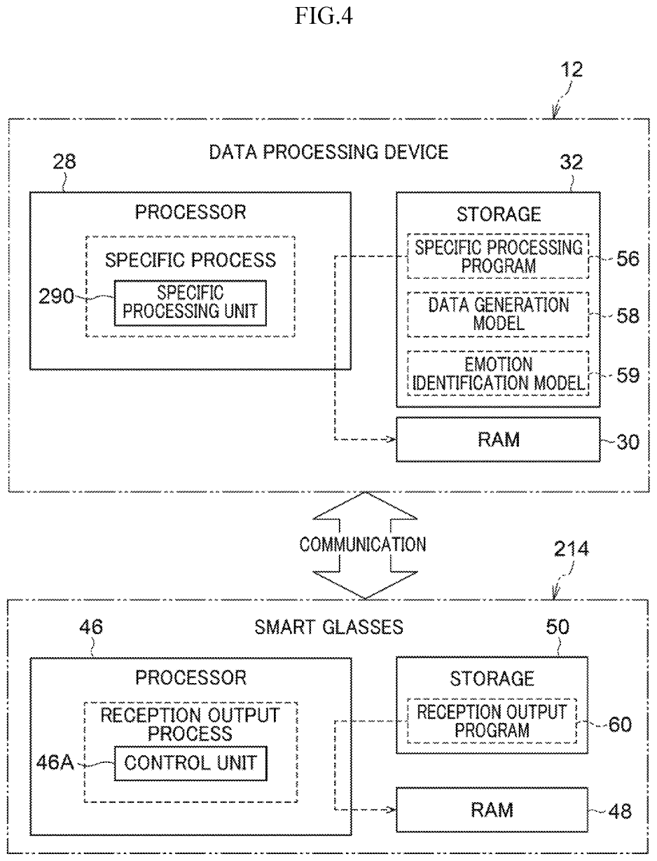

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

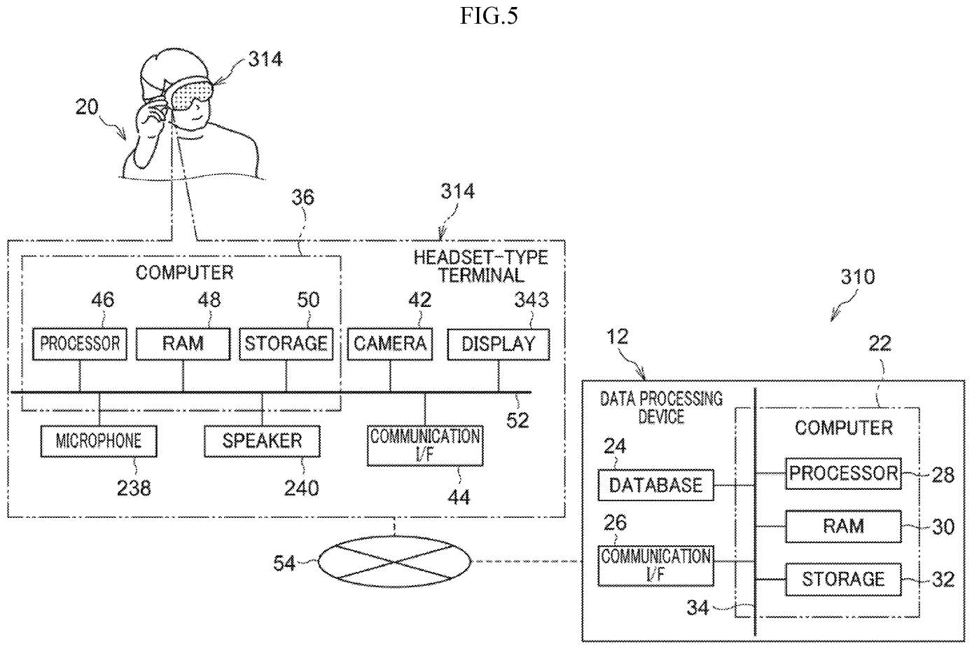

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

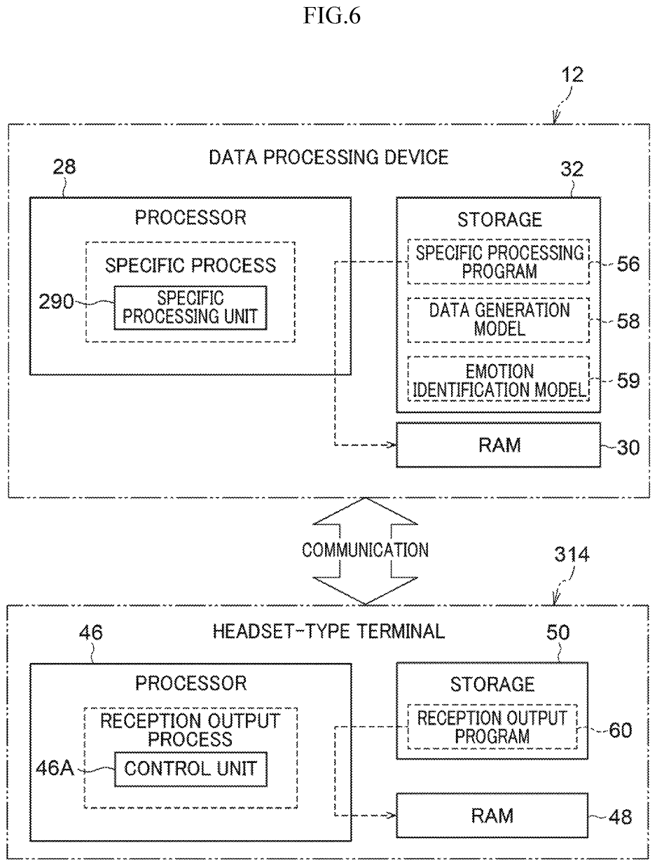

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

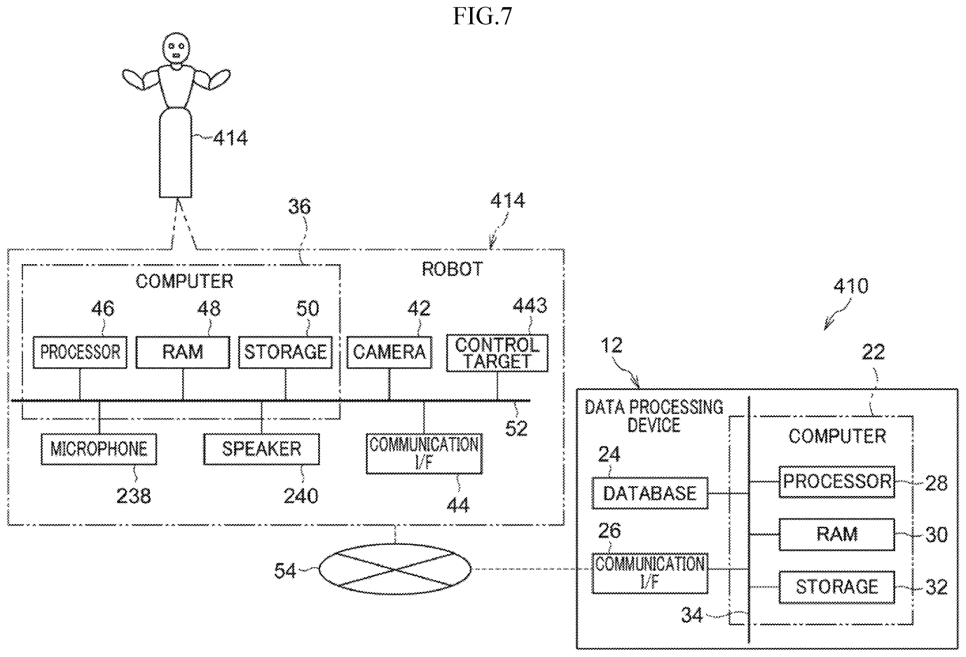

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

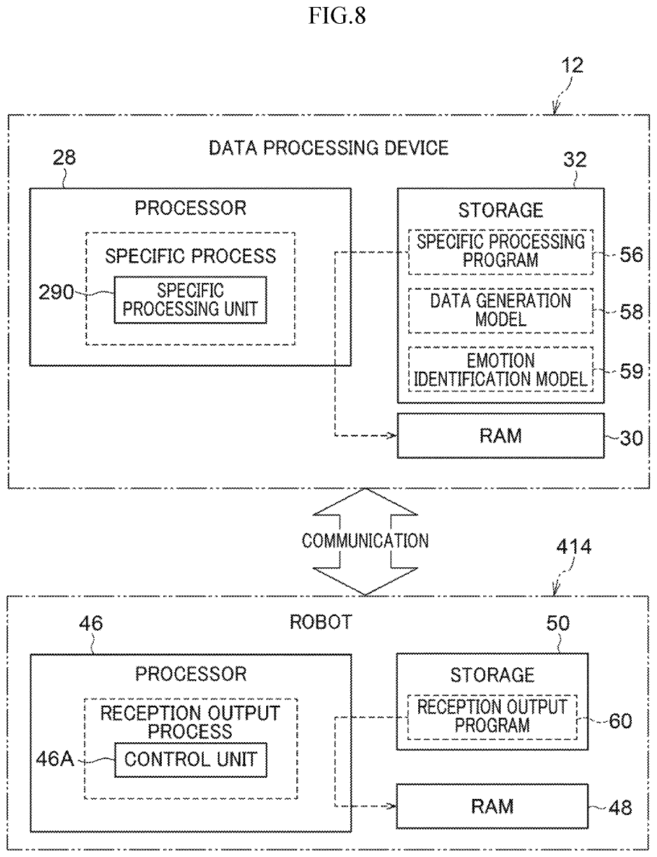

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

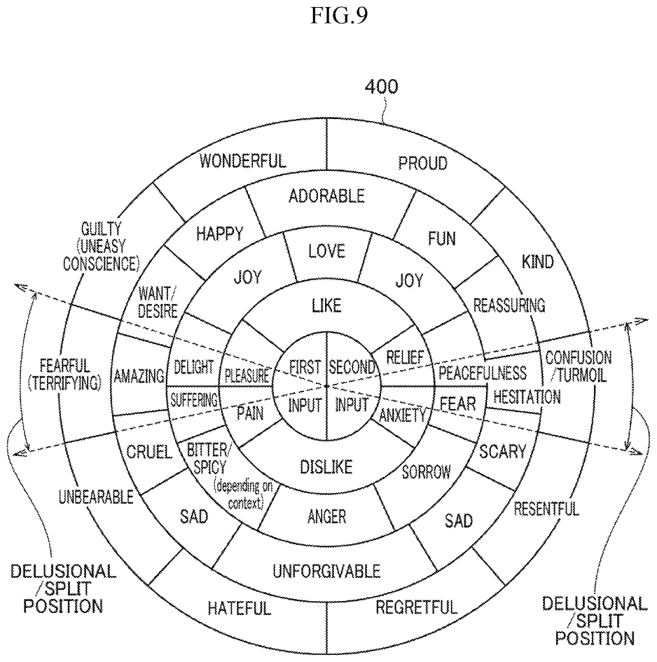

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

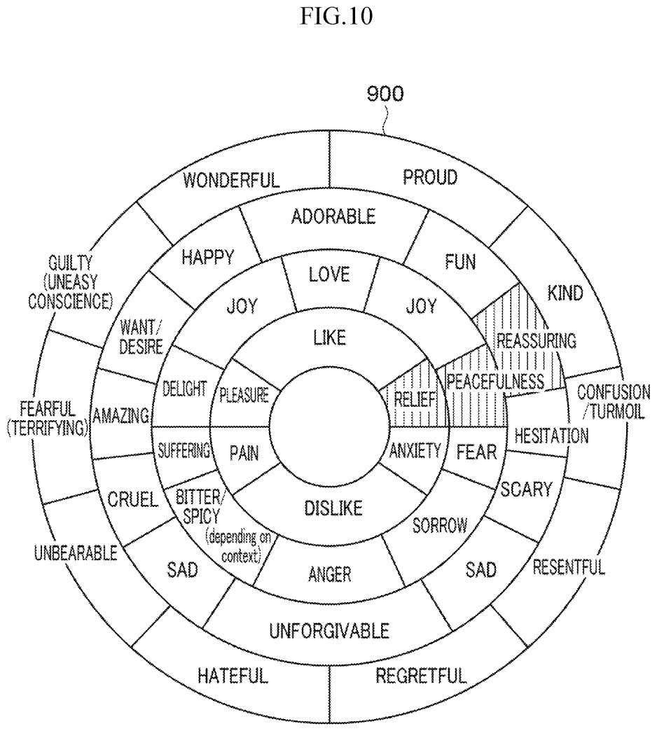

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide an input/output interface in an information processing apparatus for acquiring information expressed in natural language from a user,
generate a prompt sentence for inputting the information expressed in natural language, acquired via the input/output interface, into a generative AI model, and control the prompt sentence so as to cause the generative AI model to extract items required for an application from the information expressed in natural language,
analyze an extraction result output from the generative AI model, convert the extraction result into structured data including the items required for the application, and perform format conversion of the structured data into a data format recordable in a data management system in a data storage device,
write the format-converted structured data into a database via database management software, and generate notification information for the user based on a write result, and
cause the generative AI model to recognize an emotional state of the user from the information expressed in natural language and to generate candidate application contents corresponding to the emotional state by controlling the prompt sentence.

### Supplementary 2

The system according to supplementary 1,
wherein the processor is configured to
use a natural language processing technique included in the generative AI model to extract attribute information and important words related to the application from the information expressed in natural language acquired from the user, automatically determine a processing type or a service type related to the application based on the attribute information and the important words, and include a determination result in the structured data.

### Supplementary 3

The system according to supplementary 1,
wherein the processor is configured to
evaluate the emotional state of the user recognized by the generative AI model, set a priority or a display order of the items required for the application based on an evaluation result, and
dynamically change content or a presentation order of the prompt sentence according to the priority or the display order so as to optimize the application contents.

### Application Example 1

### Supplementary 1

A system comprising a processor,
wherein the processor is configured to
receive, via an information input-output device, information including natural language transaction information from a user,
construct a prompt sentence for inputting the received information to a generative AI model, the prompt sentence instructing the generative AI model to recognize an emotional state of
the user, to propose an application content related to an electronic transaction, and to convert the application content into a format for recording in a database,
execute the generative AI model based on the prompt sentence and the received information so as to analyze the emotional state of the user, to generate the application content related to the electronic transaction, and to convert the application content and the transaction information into structured data that conforms to a schema of the database,
perform a recording process using the structured data, the recording process including an insertion process to a relational information recording medium to safely record information related to the electronic transaction, and to notify the user of completion information based on a result of the recording process, and
apply, to sensitive information included in the structured data, at least one of an encoding process and a partial-retention process so as to maintain integrity and confidentiality of information in the database.

### Supplementary 2

The system according to supplementary 1,
wherein the processor is configured to
construct, when constructing the prompt sentence for input to the generative AI model, the prompt sentence by integrating a plurality of information elements including natural language transaction information from the user, an identifier, time information, and transaction type information into a single text sequence, and by including, in the prompt sentence, an instruction for the generative AI model to extract structured data representing at least a payment method, deadline information, location information, and identification information from the text sequence.

### Supplementary 3

The system according to supplementary 1,
wherein the processor is configured to
execute, based on the structured data output from the generative AI model, a mapping process to item names and data types corresponding to the schema of the information recording medium, a conversion process to convert date information into a standard format, a division process to divide address information into a plurality of items, and a distribution process to distribute the structured data into a plurality of table structures, and to perform, according to results of the mapping process, the conversion process, the division process, and the distribution process, a plurality of insertion processes and update processes to the information recording medium in succession.

### Example 2

### Supplementary 1

A system comprising a processor,
wherein the processor is configured to
receive, via an input/output device, a prompt sentence expressed in natural language, the prompt sentence being input by a user through a terminal and including application information,
cause a generative AI model to analyze information including the prompt sentence, and
obtain, from the generative AI model, structured information including at least a processing apparatus to be an application target, a type of requested authority, and a user identifier, based on control information that instructs the generative AI model to perform said analysis, refer to a storage device that stores setting information associated with a plurality of information processing apparatuses, on the basis of the structured information, and identify an information processing apparatus to be an application target and a communication interface for transmitting and receiving data with the information processing apparatus,
convert the structured information into a request data format corresponding to each identified communication interface, generate communication data including authentication information and authorization information, and transmit the communication data to each corresponding information processing apparatus via the corresponding communication interface,
receive response data from each information processing apparatus in response to the communication data, analyze the response data, and generate normalized result information including at least an application result, identification information, and error information,
generate, on the basis of the normalized result information, a prompt sentence including control information that instructs the generative AI model to generate a summary of the result information and an explanation text for the user, and obtain the explanation text from the generative AI model, and present the explanation text to the user via the input/output device, and
store the structured information and the normalized result information in a database as a data management apparatus.

### Supplementary 2

The system according to supplementary 1,
wherein the processor is configured to
apply natural language processing to the prompt sentence and the response data analyzed by the generative AI model, extract, as feature information, important terms, apparatus names, authority categories, and time-related information, and automatically determine, by matching the feature information with the setting information stored in the storage device, a group of related information processing apparatuses and related processing types.

### Supplementary 3

The system according to supplementary 1,
wherein the processor is configured to
cause the generative AI model to evaluate an emotional state of the user from the prompt sentence and attribute information related to the user, set, on the basis of an evaluation result of the emotional state, priorities for processing order, notification content, and reapplication guidance content included in each application within the structured information and the normalized result information, and generate a prompt sentence that instructs the generative AI model to perform optimization of application content and explanation text in accordance with the priorities.

### Application Example 2

### Supplementary 1

A system comprising a processor,
wherein the processor is configured to
provide, to a terminal serving as an information input/output apparatus, a user interface that enables a user to input information including an application content expressed in natural language and an expression including an emotion, and to receive the input information from the terminal via a communication channel,
generate a prompt sentence when inputting received natural language data to a generative AI model, supply the generative AI model with input data including the prompt sentence and the natural language data to cause the generative AI model to perform an analysis process, and
obtain analysis result data including structured information such as an application type, an item name, and an item value,
map the obtained analysis result data to a data structure corresponding to the application type when recording the analysis result data in a data storage apparatus for application management, execute a recording process on the data storage apparatus, and convert the analysis result data into a format suitable for a processing request to an external information processing apparatus,
generate, on the basis of the natural language data acquired from the user and emotion state information acquired from an emotion analysis apparatus, a prompt sentence for causing the generative AI model to generate an application content candidate that takes into account an emotion state of the user, and obtain application content candidate information from the generative AI model using the prompt sentence,
transmit the obtained application content candidate information to the terminal for display,
acquire approval information from the user via the terminal, record, in the data storage apparatus, the application content candidate information as final application information in response to the approval information, and transmit control information for instructing an application process to the external information processing apparatus, and
switch a prompt sentence to be supplied to the generative AI model on the basis of the application content and the emotion state of the user, classify the application into one of a plurality of application process types including a security-related process, a settlement-related process, and an operational-change-related process, and select workflow processing corresponding to a classification result.

### Supplementary 2

The system according to supplementary 1,
wherein the processor is configured to tokenize the natural language data received from the user by using a natural language processing technique, extract important terms, entities, and
intent information, automatically determine an application category and a related information processing function based on the extraction, and dynamically change content of the prompt sentence to be supplied to the generative AI model according to a determination result.

### Supplementary 3

The system according to supplementary 1,
wherein the processor is configured to determine an importance and a processing priority of application information on the basis of the emotion state of the user acquired by the emotion analysis apparatus, generate a prompt sentence for instructing the generative AI model to perform optimization processing of the application content in consideration of the importance and the processing priority, and control recording to the data storage apparatus and issuing of an application instruction to the external information processing apparatus on the basis of optimized application information obtained from the generative AI model.

What is claimed is:

1. A system comprising:
circuitry configured to:
receive, via a communication interface coupled to a packet-switched network, information expressed in natural language from a terminal device, and store the information in a storage device;
generate a prompt sentence for inputting the natural language information to a generative AI model, control the generative AI model to extract items required for processing from the natural language information, convert an analysis result into an appropriate format corresponding to a database schema, and write the analysis result to a database in the storage device; and
generate a prompt sentence instructing the generative AI model to recognize an emotional state of the user and to propose output content based on the recognized emotional state, and transmit the output content to the terminal device via the communication interface.

2. The system according to claim 1, wherein the circuitry is configured to generate a prompt sentence incorporating the natural language information and an instruction for the generative AI model to extract structured items from the natural language information, and obtain the structured items as an analysis result from the generative AI model.

3. The system according to claim 2, wherein the circuitry is configured to validate the extracted structured items against the database schema stored in the storage device, convert the validated items into a format matching the schema, and write the converted items to the database.

4. The system according to claim 3, wherein the circuitry is configured to apply a natural language processing technique to the natural language information to extract important keywords, automatically determine a related service based on the extracted keywords, and incorporate the related service information into the prompt sentence for the generative AI model.

5. The system according to claim 4, wherein the circuitry is configured to generate a prompt sentence that instructs the generative AI model to propose application content based on the extracted keywords and the related service, and transmit the proposed application content to the terminal device.

6. The system according to claim 1, wherein the circuitry is configured to generate a prompt sentence incorporating information written to the database and previous interaction history stored in the storage device, and input the prompt sentence to the generative AI model to generate a contextually adapted response.

7. The system according to claim 6, wherein the circuitry is configured to maintain session context data in the storage device, and update the session context data with each new item extracted from natural language information received from the terminal device.

8. The system according to claim 1, wherein the circuitry is configured to recognize the emotional state of the user by applying an emotion analysis engine to at least one of text content, vocal characteristics, and behavioral patterns in data received from the terminal device via the communication interface.

9. The system according to claim 8, wherein the circuitry is configured to adjust at least one of a content type, a presentation format, and a complexity level of the output content proposed to the user based on the recognized emotional state.

10. The system according to claim 1, wherein the circuitry is configured to receive natural language information from a plurality of terminal devices via the communication interface, extract structured items from each, and aggregate the structured items in the database to support multi-user processing workflows.

11. The system according to claim 10, wherein the circuitry is configured to generate a prompt sentence incorporating aggregated structured items from a plurality of users, input the prompt sentence to the generative AI model, and obtain organization-level or group-level output content.

12. The system according to claim 1, wherein the circuitry is configured to generate a prompt sentence that instructs the generative AI model to identify missing required items in the natural language information, and present a request for supplementary input to the terminal device via the communication interface.

13. The system according to claim 12, wherein the circuitry is configured to receive supplementary input from the terminal device via the communication interface in response to the request, extract additional structured items from the supplementary input, and update the database accordingly.

14. The system according to claim 1, wherein the circuitry is configured to monitor changes in items written to the database over time, and generate prompt sentences that instruct the generative AI model to identify trends or anomalies based on the monitored changes.

15. The system according to claim 14, wherein the circuitry is configured to transmit trend or anomaly information generated by the generative AI model to the terminal device via the communication interface as part of the output content.

16. The system according to claim 1, wherein the circuitry is configured to receive feedback from the terminal device indicating whether the proposed output content was accepted or useful, update the storage device based on the feedback, and adjust subsequent prompt sentences for the generative AI model based on the updated information.

17. The system according to claim 16, wherein the circuitry is configured to store a record of feedback associated with each proposed output content in the storage device, and use the stored records to generate personalized prompt sentences for individual users.

18. A system comprising:
circuitry configured to:
receive, via a communication interface coupled to a packet-switched network, information expressed in natural language from a terminal device, and store the information in a storage device;
generate a prompt sentence incorporating the natural language information, control a generative AI model to extract structured items from the natural language information, convert the extracted items into a format matching a database schema, and write the converted items to a database;
generate a prompt sentence instructing the generative AI model to recognize an emotional state of the user and to propose output content based on the recognized emotional state; and
transmit the output content to the terminal device via the communication interface, and update the database based on feedback received from the terminal device.

19. The system according to claim 18, wherein the circuitry is configured to apply a natural language processing technique to the natural language information to extract keywords, determine a related service based on the extracted keywords, and incorporate the related service information into the prompt sentence for proposing application content to the user.

20. A method comprising:
receiving, via a communication interface coupled to a packet-switched network, information expressed in natural language from a terminal device, and storing the information in a storage device;
generating a prompt sentence for inputting the natural language information to a generative AI model, controlling the generative AI model to extract items from the natural language information, converting an analysis result into an appropriate format, and writing the analysis result to a database; and
generating a prompt sentence instructing the generative AI model to recognize an emotional state of the user and to propose output content based on the recognized emotional state, and transmitting the output content to the terminal device via the communication interface.
